(19) United States
(12) Patent Application Publication
(10) Pub. No.: US 2026/0161350 A1
(43) Pub. Date: Jun. 11, 2026

(54) SYSTEMS AND METHODS TO GENERATE INTERACTIVE AUDIO CONTENT WHEN POINTING A LIGHT BEAM AT A PAGE

(71) Applicant: KIBEAM LEARNING, INC., Oakland, CA (US)

(72) Inventors: Lewis James Marggraff, Lafayette, CA (US); Nelson George Publicover, Bellingham, WA (US)

(21) Appl. No.: 18/974,073

(22) Filed: Dec. 9, 2024

(51) Int. Cl. G06F 3/16; G06V 10/60; G06V 10/82; G10L 15/16; G10L 15/22

(52) U.S. Cl. CPC G06F 3/167; G06V 10/60; G06V 10/82; G10L 15/16; G10L 15/22; G10L 2015/223

(57) ABSTRACT

Systems and methods are described in which machine-generated audio interactive content augment the experience of reading a book or other visual presentation. A book page may be selected by pointing a visible light beam emanating from a portable device. The selected page may be identified based on a best match within a database of page layouts to an image acquired by a device camera pointed in the same direction as the light beam. Prompts within the page layouts database associated with the selected page, page region and/or associated pages may be directed to the user and/or provided as input to an artificial neural network (ANN) trained to generate interactive content, played on a device speaker. Inputs to the ANN may additionally include descriptions of device user background and/or skills, educational and/or engagement goals, verbal responses or questions by the user, and/or the timing of user selections.

### TECHNICAL FIELD

The present application relates generally to systems and methods for machine-based generation of audio interactive content based on identifying a page or object within a page (e.g., of a book) using a light beam projected from a portable electronic device. Although the portable device may be used by anyone in a variety of configurations, the portable device may be handheld and particularly well-suited for use by a young child or learner, utilizing simple interactive signaling that lacks requirements for precision manual dexterity and/or understanding screen-based interactive sequences. Systems and methods herein employ techniques in the fields of mechanical design, ergonomic (including child-safe) construction, electronic design, computer programming, optics, computer vision, human-machine interaction, human motor control, artificial neural networks, natural language processing, large language models, small language models, and text-to-speech synthesis. Systems and methods may provide a user, especially a child or learner, with a familiar machine interface to interact with printed content.

### BACKGROUND

In recent years, the world has become increasingly reliant on portable electronic devices that have become more powerful, sophisticated and useful to a wide range of users. Although children may rapidly embrace using some aspects of electronics designed for more experienced users, young children and learners may benefit from having access to interactive devices that are small, light-weight, colorful, playful, informative, ergonomically designed (including being child safe), and easy to use. The systems and methods disclosed herein make use of advances in the fields of optics that include visible light (i.e., frequently referred to as “laser”) pointers, computer vision, artificial neural networks, portable-device sound generation, and telecommunications.

The beam of a visible light pointer (also referred to as a “laser pen”), typically used within business and educational environments, is often generated by a lasing diode with undoped intrinsic (I) semiconductor between p (P) and n (N) type semiconductor regions (i.e., a PIN diode). Within prescribed power levels and when properly operated, such coherent and collimated light sources are generally considered safe. Additionally, if directed at an eye, the corneal reflex (also known as the blink or eyelid reflex) ensures an involuntary aversion to bright light (and foreign bodies).

However, further eye safety may be attained using a non-coherent, light-emitting diode (LED) source. Such non-coherent sources (so-called “point-source” LEDs) may be collimated using precision (e.g., including so-called “pre-collimating”) optics to produce a light beam with minimal and/or controlled divergence. Point-source LEDs may, if desired, also generate a beam composed of a range of spectral frequencies (e.g., compared with the predominantly monochromatic light produced by a single laser).

Computer vision (CV) includes methods for acquiring, processing and understanding digital images. Light detection within miniature cameras typically employs complementary metal-oxide-semiconductor (CMOS) or charged-coupled device (CCD) methods. Circuitry within modern-day cameras may additionally incorporate a number of light gathering optimization and image processing steps (e.g., to reduce computational burdens on other processing components) such as automatic gain control, color balance, pixel binning, image stabilization, object detection (e.g., face and/or eye recognition, foreground versus background), and so on.

Recent developments in artificial neural networks (ANNs) have advanced the field of natural language processing (NLP) and other machine-based processing methods such as image recognition, optical character recognition (OCR), speech synthesis, and so on. Trained ANNs that enact so-called large language models (LLMs) contain up to many billions of weights that have been trained on massive datasets, largely harvested from the internet. Additionally, so-called small language model (SLM) techniques (e.g., using pruned neural networks) have been developed for situations in which processing time and/or resources (e.g., neural net hardware) may be reduced. The application of ANNs to generate interactive sequences includes prompt design techniques to formulate ANN inputs; and prompt engineering that may, for example, ensure that audio interactive content is appropriate for a target audience. Modern-day examples of LLMs include OpenAI's GPT series, Google's BERT, and Meta's LLaMa.

Speakers associated with televisions, theaters and other stationary venues generally employ one or more electromagnetic moving coils. Within portable and/or mobile devices, the vibrations of a miniature speaker may be produced using similar electromagnetic coil approaches and/or piezoelectric (sometimes referred to as “buzzer”) designs.

Advances in electronics (i.e., hardware), standardized communications protocols and allocation of dedicated frequencies within the electromagnetic spectrum have led to the development of a wide array of portable devices with abilities to wirelessly communicate with other, nearby devices as well as large-scale communications systems including the World Wide Web and metaverse. Considerations for which protocols (or combinations of available protocols) to employ within such portable devices include power consumption, communication range (e.g., from a few centimeters to hundreds of meters and beyond), and available bandwidth.

Currently, Wi-Fi (e.g., based on the IEEE 802.11 family of standards) and Bluetooth (managed by the Bluetooth Special Interest Group) are used within many portable devices. Less common and/or older communications protocols within portable devices in household settings include Zigbee, Zwave, and cellular-or mobile phone-based networks. In general (i.e., with many exceptions, particularly considering newer standards), compared with Bluetooth, Wi-Fi offers a greater range, greater bandwidth and a more direct pathway to the internet. On the other hand, Bluetooth, including Bluetooth Low Energy (BLE), offers lower power, a shorter operational range (that may be advantageous in some applications), and less complex circuitry to support communications.

Miniaturization, reduced power consumption and increased sophistication of electronics (including those applied to telecommunications) have advanced the mobile device industry. Such portable devices have become increasingly sophisticated, allowing users to concurrently communicate, interact, play, learn, monitor movement, track health, and so on. Systems and methods to add audible interactive content using a portable pointing device when reading books or other printed material may be useful.

### SUMMARY

In view of the foregoing, systems and methods are provided herein to augment visual interactions involving printed, virtual and/or visual content, with engaging, machine-produced (in real time) audible content. Systems and methods include utilizing a light-weight, simple-to-use and intuitive portable and/or handheld device that may be particularly well-suited for interactions by a child or other learner. Although the device may, in part, be accepted as a toy or “friend”, the computational flexibility embedded within the device may allow it to be used as a means for embodied learning, emotional support, cognitive development, facilitating communication, expressing creativity, play, developing mindfulness and/or enhancing imagination.

Turning the visual contents of a page (e.g., within a book or magazine) into a combined visual and aural experience (optionally supplemented by haptic and/or additional visual components) may significantly aid in the acquisition of new knowledge, skills and memories. Furthermore, a portable, light-weight, “fun” device may motivate physical movement by a child (and adults) including kinetic and kinesthetic activities.

According to one aspect, systems and methods are provided for an individual to select a page of, for example, a book or magazine using a portable and/or handheld device. As described further in the Detailed Description below, within descriptions herein, the term “page” refers to any substantially two-dimensional surface capable of displaying viewable content. Generally, the content will be “static,” i.e., the content is permanent and/or does not change, e.g., as compared to a video or other display, which may change content presented to a user while viewing. However, the content may be static temporarily, i.e., for purposes of interaction with a user during an individual session, but may be changed, e.g., by replacing different books or other content sources using an electric book or other electronic device.

Along similar lines, the term “book” refers to any collection of pages (e.g., traditional book chapter, magazine, comic strip, scrapbook). Page contents may include any combinations of text, symbols, drawings and/or images; and may be displayed in color, shades of gray, or black-and-white.

An individual may use a light beam emanating from the portable device to select (i.e., point at, identify, and/or indicate) a page including, optionally, a region, object and/or location within the page. A camera within the portable device, and pointed in the same direction as the light beam, may acquire an image of the page being pointed at. The image may include a reflection of the light beam (e.g., containing incident light reflected off the page), or the beam may be turned off (e.g., momentarily) while images are acquired (e.g., allowing page content to be imaged absent interference by beam reflections).

In either case, the location of the light beam within a camera-acquired image may be known based on the camera and light beam being co-located closely together, pointed in the same direction, and moving together within the body of the device. Beam locations within camera-acquired images may, for example, be computed based on the geometry of beam pointing and camera imaging, and/or prearranged calibration processes that empirically identify locations of beam reflections within camera-acquired images.

Selections by the device user may be signaled using any of a variety of indicating methods employing one or more portable device sensing elements. Selections (and optionally control of the light beam, such as turning on or off) may be indicated using a device switch such as a pushbutton, contact switch or proximity sensor. Alternatively, keywords, phrases, or sounds produced by a user and sensed by a device microphone may be identified to indicate selections.

Alternatively, or in addition, user control of the orientation and/or movement of the device (e.g., movement gesture, lack of substantial movement for a predetermined dwell time, striking the portable device, tapping the device against another object) sensed by an embedded inertial measurement unit (IMU) may indicate a selection. Within signaling mechanisms that produce movement of the portable device, a camera-acquired image captured just prior to any movement may be used during processes to identify a selected page or page region.

Within further aspects of the systems and methods, the processor within the portable device may acquire predetermined interactive page layouts of collections of pages (e.g., one or more books) that an individual might view. Using computer vision (CV) methods (e.g., neural networks, machine learning, transformers, generative artificial intelligence (AI), and/or template matching), a match may be determined between a camera-acquired image and a page layout image. CV-based matching may identify a selected page (e.g., within a book or magazine) viewed by the device user as well as a selected target region and/or object (e.g., drawing, word) within the page being pointed at using the light beam (e.g., at a beam location within the camera-acquired image superimposed on a matched page layout image).

Audio interactive content may be generated by an ANN trained to respond to so-called “prompts” (e.g., natural language statements, directives and/or questions) based on beam pointing and/or vocalizations by the device user. Natural language processing (NLP) may use a range of ANN architectures (e.g., transformers) including so-called large language models (LLMs) and small language models (SLMs) that have been trained on large amounts of data. Different implementations of trained NLP ANNs may combine processing steps or use separate ANNs (e.g., with different network architectures) for speech-to-text conversion, image recognition, text-to-speech conversion, sound synthesis, and so on. Generated audio content may subsequently be played on a device speaker.

Within further aspects of the systems and methods herein, one or more prompts input to a trained ANN may be formulated from: 1) predetermined information about the device user (e.g., age, preferences, geographic location) and/or the user's engagement environment (e.g., learning goals, activities for which resources are available), that may be acquired (e.g., once) during device and/or user registration and assembled in the form of one or more prompt “preambles”, 2) prompts associated with a selected page and/or page region (e.g., within predetermined interactive page layouts), triggered upon pointing the device light beam at the selected page and/or one or more page objects, and 3) verbal statements (e.g., questions, directives) by the device user acquired by a device microphone while interacting using the portable device.

Interactive page layouts may additionally include audio (referred to herein as audible “cues”), visual (i.e., displayed by the device) and/or haptic (e.g., vibrational) interactive content generated by the device, directed at the user. Such added content may directly augment the visual content of a book and/or be designed to elicit vocal responses (e.g., by asking questions or providing directives to the user) that subsequently may be a component of one or more prompts provided to the trained ANN to produce audible interactive content.

ANN prompts may also (optionally) include information about the time a selection was made (e.g., relative to times of previous selections), contextual information about adjacent regions or pages, and/or one or more predetermined storylines or themes associated with the overall book containing the selected page. Prompts may also, for example, include a user's nickname that may help make generated audible interactions appear more personal.

Either or both processes of identifying a selected page and generating an audio interaction related to beam pointing locations may be performed by one or more device processors or, alternatively or in addition, use one or more external (i.e., to the portable device) processors. Processing on the portable device may be limited (e.g., by time and/or accuracy), even if augmented by neural network accelerators designed for mobile devices. Transmitting acquired camera images, acquisition times and/or page pointing locations to one or more external processors (with access to page layout datasets) may off-load portable device processing and take advantage of more sophisticated CV approaches, ANNs, parallel processing, cloud computing, hardware accelerators, and other methods to accelerate real-time generation of interactive content.

In summary, upon pointing a light beam toward a region or object within a page, interactions facilitated by a portable device may help to bring book content “to life” by adding audible content. Augmenting visual (e.g., printed or displayed) content with interactive audible content may not only provide omnipresent, machine-based guidance while reading, but also be “fun” and/or help to maintain emotional engagement within a reading and/or learning environment. Further, the inclusion (optionally) of vocal feedback generated by a device user within prompt elements may facilitate not only a book “talking” to the device user, but a user (efficaciously) talking back to the book.

In accordance with an example, a method is provided to generate an audio interaction based on a selected page indicated by a device user using a portable device including a device processor, a device speaker operatively coupled to the device processor, a device light beam source configured to generate a projected light beam producing one or more light beam reflections, and a device camera aligned such that a camera field-of-view includes a projected beam location of the one or more light beam reflections and operatively coupled to the device processor, the method comprising: acquiring, by the device processor, one or more predetermined interactive page layouts; acquiring, by the device camera, a camera image when the portable device is manipulated by the device user such that the projected light beam produces the one or more light beam reflections off the selected page; identifying, by the device processor, the selected page based on a match of the camera image to one of the one or more predetermined interactive page layouts; generating, by the device processor, the audio interaction using one or more of a time of acquiring the camera image, the selected page, a predetermined selected page layout, one or more predetermined selected page layout prompts, the one or more predetermined interactive page layouts, and one or more predetermined interactive page layouts prompts as one or more inputs to a trained artificial neural network; and playing, on the device speaker, the audio interaction.

In accordance with another example, a method is provided to generate an audio interaction based on a selected page indicated by a device user using a portable device including a device processor, a device speaker operatively coupled to the device processor, a communications module operatively coupled to the device processor, a device light beam source configured to generate a projected light beam producing one or more light beam reflections, and a device camera aligned such that a camera field-of-view includes a beam location of the one or more light beam reflections and operatively coupled to the device processor, the method comprising: acquiring, by one or both of the device processor and a content generating processor, one or more predetermined interactive page layouts; acquiring, by the device camera, a camera image when the portable device is manipulated by the device user such that the projected light beam produces the one or more light beam reflections off the selected page; identifying, by the device processor, the selected page based on a match of the camera image to one of the one or more predetermined interactive page layouts; transmitting, from the device processor to the content generating processor using the communications module, one or both of a time of acquiring the camera image and the selected page; generating, by the content generating processor, the audio interaction using one or more of the time of acquiring the camera image, the selected page, a predetermined selected page layout, one or more predetermined selected page layout prompts, the one or more predetermined interactive page layouts, and one or more predetermined interactive page layouts prompts as one or more inputs to a trained artificial neural network; receiving, by the device processor from the content generating processor using the communications module, the audio interaction from the content generating processor; and playing, on the device speaker, the audio interaction.

In accordance with a further example, a method is provided to generate an audio interaction based on a selected page indicated by a device user using a portable device including a device processor, a device speaker operatively coupled to the device processor, a communications module operatively coupled to the device processor, a device light beam source configured to generate a projected light beam producing one or more light beam reflections, and a device camera aligned such that a camera field-of-view includes a beam location of the one or more light beam reflections and operatively coupled to the device processor, the method comprising: acquiring, by a remote processor, one or more predetermined interactive page layouts; acquiring, by the device camera, a camera image when the portable device is manipulated by the device user such that the projected light beam produces the one or more light beam reflections off the selected page; transmitting, from the device processor to the remote processor using the communications module, one or both of a time of acquiring the camera image and the camera image to the external processor; identifying, by the remote processor, the selected page based on a match of the camera image to one of the one or more predetermined interactive page layouts; generating, by the remote processor, the audio interaction using one or more of the time of acquiring the camera image, the selected page, a predetermined selected page layout, one or more predetermined selected page layout prompts, the one or more predetermined interactive page layouts, and one or more predetermined interactive page layouts prompts as one or more inputs to a trained artificial neural network; receiving, by the device processor from the external processor using the communications module, the first audio interaction; and playing, on the device speaker, the first audio interaction.

Other aspects and features including the need for and use of the present invention will become apparent from consideration of the following description taken in conjunction with the accompanying drawings.

### BRIEF DESCRIPTION OF THE DRAWINGS

A more complete understanding may be derived by referring to the Detailed Description when considered in connection with the following illustrative figures. In the figures, like-reference numbers refer to like-elements or acts throughout the figures. Presented examples are illustrated in the accompanying drawings, in which:

FIG. 1 illustrates exemplary manipulation of a handheld device by a child to select a dog within a page from a children's book that includes several additional characters and objects, by pointing a light beam emanating from the device toward the canine form.

FIG. 2 shows, within the exemplary scenario presented in FIG. 1, superposition of a camera-acquired image that has been matched using CV methods with a page layout image, where the light beam pointing location (indicated by a cross-hair target) may be known within the camera's field-of-view.

FIG. 3 is an exploded-view drawing of an exemplary portable device showing locations, aligned pointing directions, and relative sizes of a light beam source and device camera.

FIG. 4 is an exemplary interconnection layout of components within a portable device (in which some components may not be used during some applications) showing predominant directions for the flow of information relative to a bus structure that forms an electronic circuitry backbone.

FIG. 5 illustrates exemplary sources of prompt inputs to direct an ANN to generate audio interactive content based on pointing a light beam at a selected page (or page region) using a portable device.

FIG. 6 is a flow diagram illustrating exemplary processing steps performed on the portable device to generate audio interactive content based on a page (or page region) selected via light beam pointing.

FIG. 7 is a flow diagram illustrating exemplary processing elements in which ANN-based generation of audio interactive content based on beam pointing are performed by one or more connected processors, external to the portable device.

FIG. 8 is a flow diagram illustrating exemplary processing steps in which beam pointing, image capture and playing machine-generated audio interactions are performed on a portable device; and identification of selected pages and ANN-based generation of audio interactive content are performed by one or more external processors.

FIG. 9 expands upon exemplary processing steps shown in FIG. 5 to include the identifying of one or more verbal cues from a selected page layout dataset, playing cues on the device speaker, and using verbal reactions by the device user acquired by a device microphone as additional prompt input to the trained ANN.

### DETAILED DESCRIPTION

Before the examples are described, it is to be understood that the invention is not limited to particular examples described herein, as such may, of course, vary. It is also to be understood that the terminology used herein is for the purpose of describing particular examples only, and is not intended to be limiting, since the scope of the present invention will be limited only by the appended claims.

Unless defined otherwise, all technical and scientific terms used herein have the same meaning as commonly understood by one of ordinary skill in the art. It must be noted that as used herein and in the appended claims, the singular forms “a,” “an,” and “the” include plural referents unless the context clearly dictates otherwise. Thus, for example, reference to “a compound” includes a plurality of such compounds and reference to “the polymer” includes reference to one or more polymers and equivalents thereof known to those skilled in the art, and so forth.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrecited number may be a number which, in the context in which it is presented, provides the substantial equivalent of the specifically recited number.

According to one aspect, systems and methods are provided for an individual to select (point at, identify, and/or indicate) using a portable and/or handheld device, visual contents of a page (e.g., of a book) and, optionally, a region within the selected page (e.g., containing viewable objects) to augment the visual experience with machine-generated audio content based, at least in part, on the selection. The audio content may be generated by formulating one or more so-called “prompts” as inputs to an ANN trained to understand natural language and to generate interactive content that may be played on a device speaker.

Within descriptions herein, the term “page” refers to any substantially two-dimensional surface capable of displaying viewable content. Pages may be constructed of one or more materials including paper, cardboard, film, cloth, wood, plastic, glass, a painted surface, a printed surface, a textured surface, a curved surface, a surface enhanced with three-dimensional elements, a flexible surface, an electronic display, and so on.

Page content is limited only by the imagination of the author(s). Typically, for example, a children's book may contain combinations of text, symbols and drawings. The surface of a globe may, for example, contain topographical representations of land masses, structures and oceans; and include protrusions and/or depressions from the curved surface (e.g., representing mountains in contrast to valleys). More generally, page content may include any combination of text, alphanumeric characters, symbols (e.g., including the range of symbols available in different languages), logos, specifications, drawings, graphics, sketches, and/or images; and may be displayed in color, shades of gray, or black-and-white. Content may portray real or fictional scenarios, or mixtures of both.

Along similar lines, the term “book” is used herein to refer to any collection of one or more pages. A book may include printed materials such as a traditional (e.g., bound) book, magazine, brochure, newspaper, handwritten notes and/or drawings, book cover, chapter, tattoo collection, box, sign, poster, globe, slide presentation, collection of photographs and/or drawings, scrapbook, and so on. Content in a printed book may be static, i.e., may be permanent and/or unchangeable. Books (i.e., one or more pages) may also be read on an electronic screen such as a tablet, electronic reader, television, light projection surface, electronic frame, mobile phone or other screen-based device. In this example, book content may be considered static when a particular page is selected and presented on the display (i.e., until replaced by another page or book).

As just described, machine-generated audio content, augmenting the visual experience of reading a book, may be generated by an ANN trained to respond to one or more so-called “prompts”. Within the recognized areas of prompt design and prompt engineering, natural language prompts producing content may, for example, be in the form of a statement (e.g., providing context), query (e.g., expecting a factual response), prompt directive (e.g., command, instruction), and/or feedback (e.g., refinement or redirection of a previous prompt). One form of trained ANNs capable of general language understanding and producing such responsive content is a so-called large language model (LLM). So-called small language models (SLMs) have also been developed for situations in which processing time and/or resources may be limited.

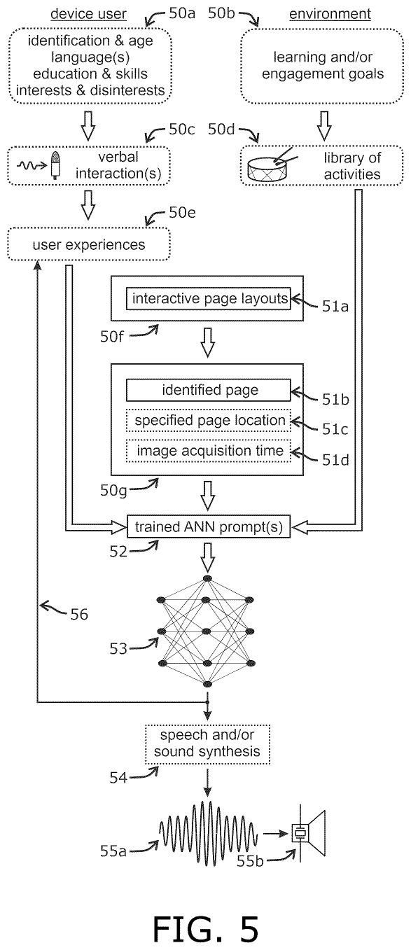

Within descriptions herein, “prompt elements” may include one or more words or text (e.g., phrases, sentences), and/or images (e.g., drawings, photographs) that may be combined using other prompt elements, scripts, topics, preferences, questions, directives, selected pages, and/or identified objects to generate one or more prompts as input to a trained ANN (e.g., as outlined in FIG. 5). Prompt elements may, for example, be predetermined (e.g., expressing background and/or user preferences), informative (e.g., statements of fact), scripted (e.g., a predefined series of related statements), conditional (e.g., including “if...then” phrasing) or querying (e.g., including one or more questions). A prompt may be used (i.e., as input) by a trained ANN to produce audible interactive content (i.e., as output) directly, or as text and/or sound elements (e.g., phonemes) that may be converted to sounds (e.g., using text-to-speech processing), subsequently played on a portable device speaker.

Prompt inputs to a trained ANN may be assembled from: 1) predetermined information about the device user (e.g., age, preferences, geographic location) and/or the user's engagement environment (e.g., learning goals, activities for which resources are available), 2) predetermined prompt elements within one or more interactive page layouts associated with a selected page and/or page region being pointed at by using a device light beam, and/or 3) verbal statements (e.g., questions, directives) by the device user acquired by a device microphone while interacting using the portable device.

Prompts may also (optionally) incorporate information about the time a selection was made (e.g., relative to previous selections) including a date (e.g., close to a preassigned birth date or anniversary) and/or and a time-of-day (e.g., compared to a meal time or bedtime). Prompt elements may, for example, include a user's nickname that may help make generated audible interactions appear more personal by incorporating the name within content (e.g., an ANN-generated limerick) and/or relating the name to a story or rhyme (e.g., pre-existing or newly generated by the ANN).

Within further examples, prompts may include contextual information about adjacent pages or page regions, incorporate one or more preassigned storylines or themes associated with a book or portion of a book (e.g., chapter). Prompt design may even comprise making the entire contents of a book (e.g., all text and/or images) and/or metadata about the book known to the ANN.

According to a further aspect of the systems and methods herein, predetermined interactive page layouts may include a page image (e.g., that may including drawings, schematics, templates, object location information) of each page (e.g., including a book cover), one or more prompts and/or one or more audio cues associated with each page, an object image of each of one or more page objects, an object identity of each of the one or more objects, one or more object prompts associated with each of the one or more objects, and/or one or more object audio cues associated with each of the one or more objects. Acquiring the one or more predetermined interactive page layouts by the device processor and/or one or more remote processors (e.g., that may provide increased computing capabilities) comprises storing the one or more layouts in a memory operatively coupled to the one or more processors.

Using CV methods (e.g., template matching, neural network classification, machine learning, transformer models) based on matching one or more camera-acquired images with a predetermined page layout image and/or object image, the position (e.g., including magnification and orientation) of the camera-acquired image within a page layout may be computed. As a result of such positioning, the device processor may identify a selected (i.e., pointed toward by the light beam) location, region and/or object(s) within the selected page camera-acquired image superimposed on a selected page layout image.

As just described, predetermined interactive page layouts associated with each selected page or page region may contain: 1) one or more prompts and/or prompt elements that may be used as input to an ANN trained to produce interactive audio content, and/or 2) audio content (e.g., including phrases, words, sentences, and/or sounds) that may be played on the device speaker. Further aspects of predetermined content within page layouts are more fully described in U.S. Pat. No. 11,989,357, filed Jul. 11, 2023, U.S. Pat. No. 12,125,407, filed Oct. 20, 2023 and co-pending application Ser. No. 18/597,855, filed Mar. 6, 2024, the entire disclosures of which are expressly incorporated herein by reference.

Within descriptions herein, the term “cue” (e.g., including audio cues, page cues, page audio cues, object cues or object audio cues) refers to such predetermined audio content within a page layout enacted upon selection of a page or page region. One or more cues directed at the user may be designed simply as an interactive component related to the page or region being pointed at, and/or to elicit a verbal response that, in turn, may be used as a prompt or prompt element input to the trained ANN.

Audible interactive content or cues acquired from page layouts and/or associated (e.g., linked or pointed at) datasets designed to initiate and/or guide interactions may include: the sound an object makes, sounds associated with an object's function, pronunciations and/or phonetic elements of an object's name or description, the spelling of an object's name, sounds or sound effects typically produced by the selected object, sounds associated with descriptions of activities using the object, an enunciated name (including a proper name) of the object, a congratulatory phrase or sentence, a portion of a name or even a single letter (e.g., begins with a letter) associated with the object, a statement about the object and/or its function, a verbal description of one or more object attributes, a question about a function and/or object attributes, a musical score related to the object, a chime indication, a quotation or saying about the object, a verbal quiz in which the selected object (or the next object to be selected) is an answer, and so on.

Additional examples of include audible or visually displayed prompts or nudges related to the beam pointing location, words or phrases that describe a scene, questions and/or cues associated with page activities and/or objects in the pointing region, introducing the next object within a logical sequence, displaying spelling(s) and/or phoneme(s) of a selected object, additional story content, questions about the story, rhythmic features related to the story (e.g., that may form a basis for haptic or vibrational stimulation of a hand or other body part of the device user), rewarding or consoling audible feedback upon making a particular selection, pointers to related additional or sequential content, actions performed if a selection is not performed within a predetermined time, and/or one or more actions (e.g., by the portable device or by a remote processor) performed upon successfully selecting a page and/or page region as a component of an interactive sequence, as described in greater detail below.

Page layouts may additionally include visual (i.e., generated by the portable device) and/or haptic interactive content, triggered upon pointing the device light beam at a selected page or page region. Added visual content may be displayed on one or more device displays and/or projected within the device light beam. Such content may augment the visual content of the page and/or be designed to elicit a vocal response (e.g., alerting the user, asking a question) that subsequently may be a component of one or more prompts provided to the trained ANN.

According to a further aspect of the devices, systems and methods herein, some LLM or SLM ANNs may accept text and/or images as input to produce text-based and/or image-based output. Within implementation cases when an ANN does not directly accept images, camera-acquired images containing text may use optical character recognition (OCR) techniques to convert image data containing alphanumeric characters and other symbols into text; and/or object identification techniques into identities and/or descriptions of objects. Contextual object detection (e.g., object identification) may involve processing steps including foreground versus background recognition, object segmentation, object identification, and so on. Along similar lines, textual (and/or phonetic sound-based) output from an ANN may be converted to speech using so-called text-to-speech synthesis methods, well known in the art.

ANNs (of varying sizes and complexity) may be used for each of the processing steps just described. These processing steps may employ separate ANNs with distinct architectures, training strategies, feedforward components, memory (i.e., time-dependent) elements, pruning strategies, and so on. Conversely, two or more processing steps may be combined within a single ANN structure. As used herein, processing steps (e.g., object identification, OCR, text-to-speech) may be implemented separately or together. Any mix of separate or collective processing steps may be used to process camera-acquired images, beam pointing times and locations, and/or page layout datasets to generate (i.e., output) audio interactive content (e.g., see FIG. 5).

Within further examples, sources of prompts or prompt elements used as input to a trained ANN may be classified (see, e.g., FIG. 5) as:
1) predetermined information (e.g., acquired when establishing a user profile) about the device user, user environment, learning and/or engagement goals, and/or book contents (e.g., that may be expressed in the form of one or more preassembled prompts);
2) metadata, storyline and/or contextual prompt elements that may be included within one or more interactive page layouts (e.g., that may also be expressed as one or more preassembled prompts, provided as input to an ANN once a page selection has been made);
3) a selected page, page region and/or location, and (optionally) image-acquisition time, involving one or more identified objects (including text) within a camera-acquired image, pointed at using a light beam; and
4) verbal indications by the device user or nearby co-participant (sensed by a microphone and, if required, converted using speech-to-text processing) that may, for example, include one or more questions or declarative statements.

Trained ANNs (e.g., LLMs, SLMs) may differ somewhat in the sequence and/or format of prompts to generate informative responses. In general, an ANN output may be effectively generated in response to a directive or question. In most implementations, in order to help shape ANN responses, a preamble (sometimes referred to as background, context or preparative statements) of one or more sentences may be used to describe user intentions and/or expectations including, for example, capabilities, hobbies, interests and so on.

The following exemplary prompt elements embedded within single quote marks (‘) using predetermined information about a child (e.g., provided when a device and/or device user is registered) may (e.g., with appropriate permissions) be included as one or more preamble prompt elements: p1 ‘My name is [nickname].
I live in [location].
I am an [identity], [age] years old, in grade [grade], and can speak [language(s)].
I like [interests] and would like to learn more about [learning topics].’
   where [nickname] may be used to address the individual, [location] is a geographic location and/or cultural community, [identity] is an ethnic and/or gender identity, [age] is a numerical value, [grade] indicates an educational level, [language(s)] indicates proficiency in one or more languages, [interests] include topics that may be of interest to the user, and [learning topics] may be a list of learning goals (e.g., that may have been identified by a parent, guardian or teacher).

An awareness (e.g., stated within prompt preamble elements input to the ANN) of geographic location and/or cultural norms may help to make ANN-generated responses more accepted and/or meaningful. Providing a name or nickname of the device user may make responses appear more personal and/or engaging. Informing an ANN of skill levels (e.g., in mathematics, music, coding, etc.) and/or interests (or conversely, challenges and/or disinterests) may generate responses with appropriate levels of detail (as described further below). Indicating knowledge elements known to the user may help to focus generated interactions and/or avoid boredom.

Prompt elements may be associated with a selected page, a selected page region, a page location and/or one or more objects being pointed at by the light beam and, optionally, a time of acquiring a camera-based image (taking into account any processing delays, if needed). Prompt design may be based on 1) content within a predetermined page layout, and/or 2) one or more objects identified in real time within camera-acquired images in the beam pointing region.

As examples, if the light beam points towards an object identified (e.g., using CV methods in real time, or as a prompt element within a page layout) as an elephant, more generic (e.g., that may be applied to most identified objects) include:
‘Describe an elephant.’
‘What sounds are made by an elephant?’
   Examples of more specific prompts in which prompt elements about elephants (i.e., in the region of a page being pointed at) may have been included within page layouts include:
‘How much do elephants weigh?’
‘What do elephants eat?’

Prompt elements may also be generated to take into account conditions determined at runtime (i.e., when manipulating the portable device). For example, machine-generated audible interactions may be a component of a rapid, back-and-forth exchange related to book and/or page contents. Under such conditions, user engagement may be enhanced by limiting the length of audible content (e.g., up to a specified number of words) generated during some exchanges. This may be enacted, for example within a preamble or as a part of an action statement:
‘In one hundred words or less . . . ’

Within additional examples, audible interactions may be made more engaging if the contents and/or writing style of a page, nearby or associated pages, or entire book may be known to the ANN. Text may be scanned with camera images in real time (e.g., applying OCR) and/or selected content or the entire contents of a book may be stored within predetermined page layouts and made available. As an implementation detail, some form of notation may be used to distinguish such preamble or background material (e.g., from declarative or questioning

statements used to trigger an ANN response). Within some LLM-and SLM-based ANN implementations a double quote (“) surrounding background content may be used to make such distinctions.

One or more contextual elements of a book, book title, and/or pages within a book, may be included within an ANN prompt set (including datasets pointed to by a page layout database). Such prompts may be sufficient to allow the ANN to identify a specific book that has been used to train the ANN (e.g., based on author, title and/or contexts). Thus, in some cases, the ANN may have insights (e.g., acquired during training) about a page or object being pointed at that are not directly expressed within the prompt dataset.

Whether applied to a prompt (i.e., provided as input to an ANN) or cue (i.e., played directly to a user on a device speaker), scripting techniques may be used that may structure prompts and/or cues to, for example, incorporate (e.g., so-called real-time) information available during device use. Such scripting methods may take advantage of traditional coding structures such as “if . . . then” conditional statements, repeat loops, ensuring all necessary information is available to execute a next step, sequencing inputs (e.g., button press) and outputs (e.g., verbal cue), controlling the timing of each step, and so on.

Within further examples below, the notation [topic] is used to refer to a prompt element based on a real-time selection. The term [topic] may, for example, refer to an object being pointed at using a light beam and/or identified using CV, a word or collection of letters and/or symbols being pointed at and identified using OCR, an object and/or text prompt element that has been preassigned within a selected page layout or page region, a word or phrase sensed by the device microphone (e.g., identified via speech recognition), or an activity that may be viable as a result of device location or time-of-day.
‘Find all the [topic] within the page by pointing at each one.’
‘Show me the largest [topic].’
‘Find something that rhymes with [topic]?’
If a user's interest includes music, then ‘Which musical instrument produces [sound topic]?’

During such sequences, a child may not only learn how to pronounce words but also recognize sounds typically associated with selected topics. Scripted sequences may additionally compare real-time conditions (e.g., fun versus learning environment) with the educational and/or entertainment value of page content (e.g., predetermined within a page layout), whether a page or page object is anticipated as a next discovery within a serial sequence (e.g., storyline, alphabetical or numerical sequence), and so on.

Within further examples, when no prompt or prompt topic is available within interactive page layouts (e.g., a book that has been scanned, but not fully curated), “generic” prompts may be formulated by the device. For example,
‘Describe [topic].’
‘What sounds do [sound topic] sound make?’

A generic cue may also be given to a device user in order to (indirectly) generate an ANN-based audible response. For example (without utilizing any page layout derived cues associated with a selected page), the following cue may be played on the device speaker:
‘Describe what you see.’
   where a user response (sensed by the device microphone) may be conveyed to the ANN.

Along similar lines, generic prompts utilizing context maintained by the ANN (e.g., within so-called memory or feedback neural network structures) may be used to maintain continuity regarding almost any topic. For example, a directive appended to an ANN-based interactive sequence may include:
‘Describe more.’

Such generic cues and/or prompts may be repeated (e.g., without requiring further information). Trained ANNs (e.g., LLMs and SLMs) generally provide alternative descriptions and/or additional information when a repeated directive or question is encountered. Thus, when a user indicates interest (or confusion) by, for example, repeatedly articulating and/or querying (e.g., by repeating the pressing of a device pushbutton or dwelling on a particular page or page location), a topic may be elaborated upon using such prompts. Such repeated topic examination via repeated prompts may be enacted any number of times, providing an ability to explore or reinforce a particular topic to any sought-after depth and/or understanding.

The ability of an ANN to generate differing content when provided the same (or similar) inputs, may also be utilized when screening content to assess factors such as age-appropriateness (inappropriate words), inadvertent disclosure of information that may be considered personal (detecting a physical address), cultural sensitivities, and so on. Such screening may search ANN-generated content against a predefined database of (inappropriate) words and/or content, and/or use ANN-based natural language processing techniques to “ask” if the generated content is appropriate for a person with the provided background. If content is found to be inappropriate, the ANN may be requested to generate another response and/or additional prompt elements may be included to guide response content.

Within further examples of systems and methods herein, a learning environment may include formal educational goals specified by teachers, parents and/or guardians; and/or more informal ambitions or interests provided by the device user and/or others (e.g., parents, guardians, relatives, peers). Such interests and/or goals may be stated within preamble prompt statements, and/or embedded within directive or querying prompts. ANNs may be made aware of such goals and/or the availability of libraries, tools, accessibility aids, and/or other resources that may cater to such interests and/or needs.

As examples, the playing of existing or newly generated (i.e., by an ANN) music may contribute to interests in music, audible composition or poetry may cater to interests in literature, and translated speech may help enhance linguistic skills in other languages. Exemplary prompt directives in each of these areas include:
‘Generate a chord progression for the lyrics within [topic].’
‘Express a poem about [topic].’
‘Describe [topic] in French.’

An ANN (as well as the design of ANN prompts) may also be informed of past experience(s) by a device user. User experiences may, for example, be included within preamble prompt elements. Knowledge of baseline levels of experience may help tailor audible interactions to be more informative and avoid repetition. Such records of past user experiences may be updated following each interaction or interactive session (see, e.g., FIG. 5).

Optionally, background data including information related to the device user, experiences logged during previous interactive sessions, and/or any limitations (e.g., required parental permissions) for device use may be encoded in a form that may be acquired (e.g., at the beginning of any new interactive session). For example, user identity and/or information may be loaded (e.g., into device memory) using a so-called QR code identified by pointing the device camera at the QR code image. Such linking of an individual user to registration processes and/or past interactive sessions may provide continuity among sessions, enable privacy among different device users and facilitate tracking of progression (as described further below) in areas such as reading comprehension, engagement, skills development, and so on.

Alternatively, or in addition, facial recognition may be used (e.g., with appropriate permissions and/or safeguards) to identify a device user (particularly if a device is shared among multiple users) and/or to aid in session continuity (e.g., user experiences) and tracking (e.g., reading progression). The device camera may be directed (e.g., momentarily) toward a device user's face (e.g., with the pointing beam turned off) and camera-acquired images may be compared with previously registered users to determine a match in identity.

Within further examples, context of page contents may help to identify one or more roles or functional contributions of pages and/or objects being pointed at, particularly related to other pages and/or objects within the book. Contextual elements may include broader generalizations including whether content is intended to be instructional, fictional, funny, entertaining, a mystery, designed for a specific age group, associated with activities during a particular time of year (e.g., birthday, sporting event), and so on. Additionally, context may, for example, help to describe if an object being pointed at is a central focus of one or more storylines, or simply a contributing component.

As examples of storyline and contextual elements helping to form ANN prompts, if the light beam is pointed toward a drawing of a character swinging a baseball bat, and a context of the story is about playing baseball, then a generic prompt element might include:
‘Play sounds that are heard when playing baseball.’

Examples of more specific prompts about baseball (e.g., acquired from a page layout database) utilizing more specific prompt elements (and based conditionally on the age range of a device user) might include:
‘What is a foul ball?’
If [age] is greater than seven years, then ‘What is an RBI?’
If [age] is greater than seven years and [geographic location] is defined, then ‘Who on a baseball team near [geographic location] has the most RBIs.’
   where [age] is the device user's age and RBI represents “runs batted in”.

Within further examples herein, prompt elements and/or assembled prompts may be unknown to the device user. During an interactive session, the user may simply open a book or magazine, and point the light beam toward a page. Although a user may help direct interactions in real time via verbal questions or directives, such verbal guidance is not required during ANN-based generation of interactive content. Predetermined background materials (e.g., user age, learning goals) may be provided to the ANN prior to an interactive session. Once a page and/or page object has been selected, predetermined prompt elements related to the page along with, optionally, nearby pages and/or the entire book, may be provided to the ANN.

When a portion of a book or an entire book (including text and/or figures) is provided as input to a trained ANN, prompts may be designed to ask questions and/or elicit narratives based on the provided content. This process may reduce or even eliminate efforts required to establish predetermined page layout prompts, including storyline context(s). Absent relying on such predetermined prompts or prompt elements, generic prompts may include
‘Summarize the story.’
   If a portion of a book is provided, then a prompt may include
‘Describe what is happening.’

The identification of a page region or object being pointed at using the light beam may additionally be used to initiate ANN-generated audio interactions in the context of a story provided to a trained ANN. If “[identified object]” is identified (based on matching a page layout or in real time) using the device light beam, then a prompt may include
‘Describe the role of [identified object] in the story.’
   Knowledge of a portion of the storyline, or the entire story, may also facilitate and/or ANN-generates responses to prompts based on user reactions detected using a microphone.

Within further aspects of the systems and methods, when using audio data collected by a device microphone to contribute to one or more prompts, processing steps may include determining whether a directive or question is present within an audio dataset (e.g., sufficient to generate an audible interaction). Datasets may be flagged during natural language processing as containing noise, laughter and/or other non-verbal elements requiring further vocal input. When verbal elements are identified, it may be valuable when formulating prompts to know if a question or directive is present and/or if it has been stated completely.

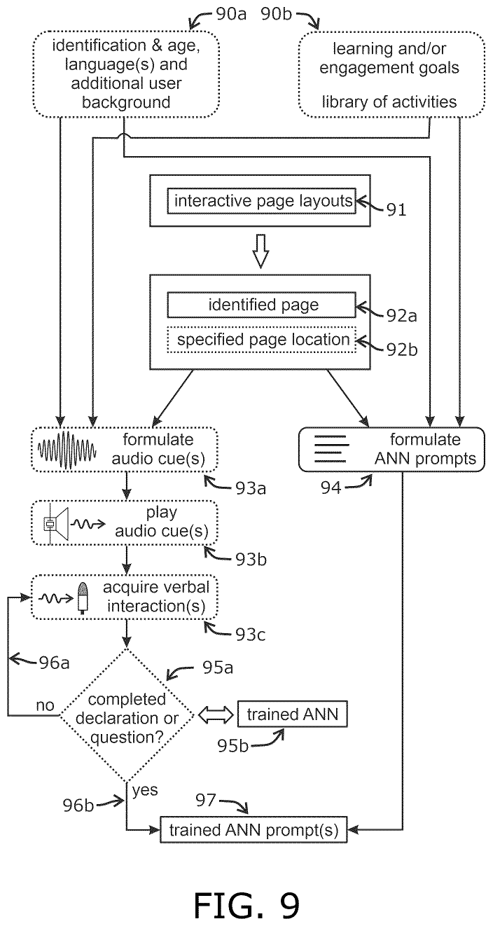

ANN-based processing of the audio snippet (e.g., hidden to the device user) may help to identify whether an audible response might be expected by the device user (see, e.g., FIG. 9). For example, one or both of following prompts might be input to a trained ANN:
‘Is “[microphone-acquired dataset]” a question or directive?’
‘Is “[microphone-acquired dataset]” a complete sentence?’

If neither a question nor a complete sentence is present, then further microphone data may be acquired to continue the search for coherent user input. If the sampled dataset includes a question or directive, then the data may be redirected to the trained ANN (i.e., absent being embedded within a question with double quotes) to provide a machine-generated audible answer. If sampled data include a complete sentence, then the sentence may simply be provided to the ANN (e.g., absent anticipating a reply). During such determinations and/or when prompt elements are extracted from speech or other audio content collected using a device microphone, there is no requirement for a user awareness of prompt formulation or even which prompt elements have been used to generate an ANN-based audible interaction.

Alternatively, or in addition, because the foundational training regimes of LLM-and SLM-based ANNs are centered upon anticipating the next word(s) within a sequence of words, a prompt that includes anticipated words to complete a sentence or question may immediately (e.g., without the user completing the sentence) be input to the ANN. The ANN-based response may then be felt as engaging and/or connected to the device user (hopefully absent the feeling of being interrupted).

According to further aspects, devices, systems and methods are provided in which one or more predetermined page layouts are known to one or more processors. The device user may point to a location within a selected (i.e., by the user) page using a light beam generated by the device. A camera within the portable device, and pointed in the same direction as the light beam, may acquire one or more images of the location or region within a page being pointed at by the device user. When the beam is turned on, and as long as a surface is sufficiently reflective, a camera-acquired image may include a reflection of the light beam (e.g., containing incident light reflected off the page).

Alternatively, the beam may be turned off as images are being acquired. Turning the beam off (e.g., at least momentarily during camera-based image acquisition) allows camera-acquired images with page content to be identified (e.g., using CV methods) absent interference by light beam reflections. Even while the beam is turned off, because both the beam and camera move at the same time (i.e., affixed to, or embedded within, the device body), the location or region a beam is pointed toward within a camera image may be known regardless of the physical position, pointing direction, or overall orientation of the portable device in (three-dimensional) space.

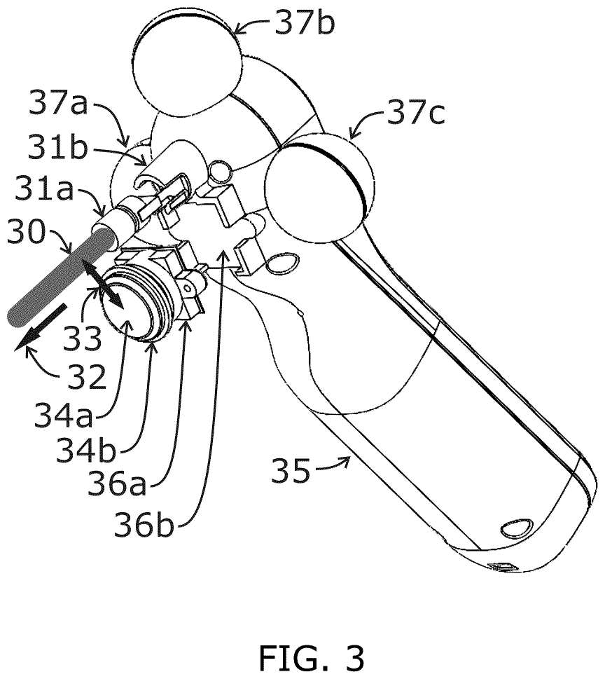

Design and construction of the portable device may strive to place the beam reflection at the center of camera images. However, given a small separation (e.g., as a result of physical construction constraints illustrated in FIG. 3) between the beam source and the camera sensor, the beam may not appear at the center of camera images at all working distances.

The pointing directions of a beam and camera field-of-view may be aligned to converge at a preferred working distance. In this case, the beam may be made to appear about at the center of camera images, or some other selected camera image location, over a range of working distances. In this configuration, as the distance from the portable device to a reflective surface varies, the location of the beam may vary over a limited range (generally, in one dimension along an axis in the image plane in a direction defined by a line passing through the center of the camera field-of-view and the center of the light beam source).

At a particular working distance (i.e., from the portable device to a reflective surface), a location of a reflection may be computed using geometry (analogous to the geometry describing parallax) given the direction of beam pointing, the direction of camera image acquisition and the physical separation between the two (see, e.g., FIG. 3). By keeping the physical separation between the beam and camera small, a beam pointing region within camera images may be kept small over a range of working distances employed during typical applications.

Alternatively, the beam and camera may be aligned to project and acquire light rays that are parallel (i.e., non-converging). In this case, a reflection may be offset from the center of the camera's field-of-view by an amount that varies with working distance. The separation between the center of camera images and the center of the beam decreases as working distances increase (e.g., approaching a zero distance at infinity). By keeping the physical distance separating the beam and camera small, the separation may similarly be kept small.

Regardless of alignment configuration, the location of a light beam within a camera-acquired image (including when the beam is turned off) may be known based on the camera and beam being co-located within the body of the portable device, pointed in the same direction and moved together. Beam locations within camera-acquired images may be computed based on the separation and pointing geometry of the beam and camera, and/or determined empirically via a calibration process (e.g., prior to deployment), for example, using the following steps:
1) acquire a baseline image (e.g., from a featureless surface) that includes no reflection by the projected light beam;
2) acquire a light beam reflection image that includes one or more reflections produced by the projected light beam;
3) compute a subtracted pixel intensity image based on the baseline image subtracted from the light beam reflection image; and
4) compute a beam pointing location based on pixels within the subtracted pixel intensity image that exceed a predetermined light intensity threshold.

A beam pointing region may be identified based on locations of pixels that exceed the intensity threshold, and/or a singular beam pointing location may be determined from a computed central location of pixels that exceed the threshold intensity (e.g., two-dimensional median, average, center of a beam spread function fit to an intensity profile). Calibrations may be performed at different working distances to map the full extent of a beam pointing region.

Within additional examples herein, identifying an object or location being pointed at within camera-acquired images may, with the beam turned on, be based on identifying a beam reflection as a region of high luminosity (e.g., high intensity within a region of pixel locations). Identifying the location of such beam reflections may also take into account the color of the light beam (i.e., identifying higher intensities only within one or more colors associated with the light beam spectrum).

Alternatively, or in addition to a projected light beam, pointing and/or selecting a page and/or page region using a portable device may be implemented using a physical pointer (e.g., stylus, rod, pen). Operationally, device physical pointing may function in a similar fashion to pointing using a light beam, as described above.

As examples, a pointing arm may be a permanent component of the portable device, affixed (e.g., screwed in, clamped on) only during use, or hinged (or other attachment mechanism that allows movement) to “flip” into position when desired. The length of the pointing arm may (optionally) be selected to provide a desired field-of-view (e.g., by encouraging a desired working distance) within images of a co-aligned camera when the tip of the arm touches viewable content.

Additionally, contact with a page or other viewable content may be signaled to the portable device using, for example, a contact, proximity-detecting (e.g., capacitive) or (miniature) pushbutton switch. Such physical pointer signaling enacted by the user may be interpreted by the portable device as indicating that a selection has been made.

Additional (optional) design elements of the physical pointer include a narrow profile to reduce interference with the acquiring of images by the co-aligned camera, a rubber-like (e.g., constructed of a soft plastic or foam) flexibility of the pointing arm and/or a blunt end to avoid physical injury. A physical pointer may also be illuminated (e.g., by partial internal reflection) to signal when pointing is expected (and/or other indications to the device user). Compared with pointing using a light beam, a portable device with a physical pointer may be less expensive to construct, require little or no battery power, and avoid precision manufacturing processes frequently associated with optical designs.

As yet another alternative to the use of a projected light beam to select objects and/or locations in the vicinity of the device, a physical “sight” (e.g., that includes one or more pointing and/or visually aligned elements) co-aligned with the field-of-view of the device camera may be used to point toward locations during user interactions to make selections. Such sights may be composed of a single viewing port (e.g., with an integrated crosshair), two or more structures providing a visual alignment with a target location within camera-acquired images, or a continuous (e.g., tube-like) structure that, when visually aligned by the device user, a location, object and/or page region being viewed may be identified as an element of the selection process.

Optionally, each of these sighting structures may include one or more optical elements that may, for example, further isolate a selected region being viewed. Such optical elements may include a cross-hair, concentric circles or other viewable forms that may be superimposed on the scene viewed through the sight. Alternatively, or in addition, elements may provide optical magnification, allowing the device user to “zoom in” on the scene being viewed. Optical elements may expand or contract a region being viewed, allowing objects and/or locations in a region to be selected with greater fidelity and/or ease. Optical zoom may be adjusted in real-time, allowing a user to select a degree of viewing magnification. Control of optical zoom may be enacted via one or more moveable optical elements within the sight path. For example, a slider attached to an optical element may allow a lens to be moved within a sighting tube.

Device configurability may help compensate for the visual acuity of a device user and/or the mechanical ability to point the portable device (e.g., in the presence of a tremor). Compared with pointing using a light beam, a portable device with a sight may be less expensive to construct, require little or no battery power, and avoid precision manufacturing processes frequently associated with optical designs. Compared to a portable device with a pointing arm, a device that uses a sighting mechanism may be more compact.

As further aspects of systems and methods herein, the device user may indicate (i.e., to the portable device) that the beam or pointing arm is pointed toward a selected object and a selection is being made. Such indications may be made via a range of interactive methods, such as:
1. pressing or releasing a switch (e.g., pushbutton, or other contact or proximity sensor) that is a component of the portable device,
2. providing a verbal indication (e.g., saying “now”) sensed by a portable device microphone and identified (e.g., classified using natural language processing) by the device processor or a remote processor,
3. point the beam at a page or object (i.e., absent substantial movement) sensed by a device IMU or based on movement within camera-acquired images for a predetermined (e.g., based on user preferences) so-called “dwell” time,
4. orienting the device in a predetermined direction (e.g., vertically relative to the gravitational pull of the earth, tipping the device forward) sensed by a device IMU, or
5. gesturing or tapping the portable device, also sensed by a device IMU.

Within these latter exemplary cases, in which signaling movements of the portable device by the user (e.g., gesture, tap) may produce motion within the camera's field-of-view, a stationary image may be isolated (e.g., from a continuously sampled series of images) prior to any user action that might produce such movement. For example, a camera-acquired image immediately prior to any motion-based signaling may be used within CV-based processes to identify a location or viewable object being pointed at.

Within further examples, a method to implement dwell-based methods includes ensuring a number of consecutive images (e.g., computed from desired dwell time divided by frame rate) to reveal a substantially stationary viewable object and/or beam reflection. CV techniques such as template matching, computer vision, or neural network classification may be used to compute one or more spatial offsets comparing pairs of successively acquired camera images. Image movement (e.g., to compare with a dwell movement threshold) may be computed from the one or more spatial offsets or a sum of offsets over a selected time.

When determining rapid and/or precise dwell times, movement measurements based on camera images demand high frame rates, and resultant computational and/or power needs. Alternative methods to determine if a sufficient dwell time has elapsed include using an IMU to assess whether the portable device remains substantially stationary for a predetermined period. Gesture-based selection indications may include translational motion, rotation, lack of movement, tapping the device, and/or device orientation. User intent(s) when making a selection may also be signaled by:
1. motion of any sort (e.g., above IMU noise levels),
2. movement in a particular direction,
3. velocity (e.g., in any direction) above a threshold value,
4. a gesture using the portable device (e.g., known movement pattern),
5. pointing the portable device in a predetermined direction,
6. tapping a handheld device with a digit of an opposing hand,
7. tapping the portable device with a striking object (e.g., stylus),
8. striking the portable device against a solid object (e.g., desk), and/or
9. striking the portable device against an additional portable device.

Tap locations may be determined using distinctive “signatures” or waveform patterns

(e.g., peak force, acceleration directions) within IMU data streams (i.e., particularly accelerometer and gyroscope data) that vary, depending on tap location. Determining tap location on the surface of a portable device based on inertial (i.e., IMU) measurements and subsequent control of activities are more fully described in U.S. Pat. No. 11,614,781, filed Jul. 26, 2022, U.S. Pat. No. 11,947,399, filed Mar. 4, 2023, and co-pending application Ser. No. 18/412,956, filed Jan. 15, 2024, the entire disclosures of which are expressly incorporated herein by reference.

According to further aspects of systems and methods herein, the restricted nature of comparing camera-based images with a page image or template database may simplify training and classification processes to determine the presence, or not, of a match with a page layout. Training of classification networks may be confined to a predetermined page layout database (library of children's books), a data subset such as a particular collection of books or magazines, or even a single book or book chapter.

Such confined datasets may also allow relatively simple classification networks and/or decision trees to be implemented. Optionally, classifications may be performed entirely on a portable device (typically with limited computing resources) and/or without transmitting to remote devices (e.g., to access more substantial computing resources). Such classifications may be performed using SLM (and/or other CV and AI) approaches using hardware typically found on mobile devices. As examples, MobileNet and EfficientNet Lite are platforms designed for mobile devices that may include sufficient computational power to match camera-acquired images (e.g., including those in which image resolution may be reduced) within book pages.

Classifications based on known page and/or object image datasets (e.g., relatively small compared with global classification methods to identify an object) may also facilitate greater accuracy when identifying page content being pointed at using a light beam. Such confined classifications may be more robust because: 1) images are only being compared to a database of discoverable pages (e.g., not to all possible objects throughout the world), 2) training may be performed using the discoverable pages, and 3) CV match thresholds may be adjusted to help ensure the intents of device users are accurately and quickly determined.

Thresholds for locating a camera-based image within a page may be adjusted based on factors such as hardware (e.g., camera resolution), environment (e.g., lighting, object size), a specific application (e.g., the presence of multiple objects similar in appearance), categories of users (e.g., younger versus older, experienced versus novice) or a particular user (e.g., considering prior successful object selection rates).

Either or both processes of 1) identifying a selected page pointed at by a beam, and 2) generating audio interactions may be performed on the portable device or use external computing resources. Artificial intelligence (AI) approaches used to generate interactions include generative AI that may produce responses based on a single interaction. At the next level, agentic AI may include sophisticated reasoning and iterative planning to interact in a multi-step fashion. An ability to generate a personalized interaction may arise not only from tracking the background (e.g., age, educational level) and preferences of an individual (e.g., provided as preamble, as described above) but also from the ability of AI approaches including agentic AI to learn and adapt (e.g., based on user reactions and feedback).

Transmitting acquired camera images, acquisition times and/or page pointing locations to one or more external processors (with access to page layout datasets) may off-load portable device processing and take advantage of more sophisticated CV approaches, large-model ANNs, parallel processing, neural network hardware, hardware accelerators (e.g., graphics processing units, GPUs), AI accelerators, cloud computing, agentic AI and other methods to accelerate real-time generation of interactive content.

Steps to initiate actions on one or more external devices may include transmitting, to the one or more remote processors, interactive page layouts, any contextual and/or object templates, any or all camera images (particularly images used during object selection), acquisition times when camera images were acquired, positioned images (e.g., determined position, orientation and magnification parameters), beam pointing locations, specified object(s) and/or location(s) within page layouts, one or more actions within the page layout dataset, and feedback elements produced by the portable device. A lack of making any selection within a prescribed time or indicating a selection that does not produce a match with any acquired template may also be conveyed to an external processor.

When dwell is used to indicate or identify when a location is being specified by a device user, additional dwell thresholds and measurements may be included within transmitted data including the two or more camera images used to measure movement, measured image movement, IMU-based measurements of movement (e.g., gesture or tap), and/or predetermined dwell amplitude and/or time thresholds. Data related to other signaling mechanisms used to identify when a selection is being made by the device user may also be transmitted including voice or audio indication(s) by the device user (e.g., sensed by a device microphone), the timing and identification of device switch (or other portable device sensor) activation or release, and so on.

Interactions facilitated by a portable device may help to bring printed or displayed content “to life” by adding audio, additional visual elements, and/or vibrational stimulation felt by a hand (or other body part) of a device user. Printed content augmented with real-time interactive sequences including feedback related to page content may not only provide machine-based guidance while reading, but also be “fun”, helping to maintain emotional engagement particularly while reading by, and/or to, a child.

Additionally, adding audio content to the pages of a book may promote bonding, learning and/or language development. The reading of a book may be augmented by adding queries, questions (for a parent or guardian, and/or the child), additional related information, sounds, sound effects, audiovisual presentations of related objects, real-time feedback following discoveries, and so on.

The portable device may, for example, aid in areas related to basic reading, literacy, dialogic reading, CROWD (i.e., Completion, Recall, Open-ended, WH-prompt [where, when, why, what, who], and Distancing) questioning, mathematics, and understanding of science and technology. Additionally, the device may help traverse a learner's Zone of Proximal Development (ZPD) by providing omnipresent (machine-based) educational support. The ZPD is a framework in educational psychology that separates what a learner can do unaided versus what a learner can do with guidance (additionally versus what a learner cannot do, even with guidance). Making a book interactive, particularly a book that challenges a learner, may provide always-available support and guidance to transition through a ZPD in different topic areas, absent a human (e.g., teacher, family, peer member).

An omnipresent tool for such support and guidance may not only reduce needs for an individual with adequate literacy and/or skills to be present, but also allow for machine-based transitioning through the ZPD to occur at a time, place, comfortable environment and rate of a learner's choosing. Further, a personalized device (e.g., in appearance, verbal dialect, knowledge level based on a learner's individual background) that appears tireless and that has been used previously (e.g., with repeated rewarding feedback) may further aid in a learner acceptance, independence, self-motivation and confidence using the portable device. Maintaining a challenging environment by bringing books to life may avoid boredom and/or loss of interest (and additionally, at an interactive rate that may avoid becoming overwhelmed).

According to further aspects, optionally, the portable device and/or a remote processor may simultaneously perform ongoing, real-time assessments of engagement, language skills, reading abilities and/or comprehension. Assessment metrics may, for example, include the measured times a child spends interacting, success rates in discovering objects based on queries (particularly within different topic areas including areas of identified interest such as sports, science or art), times required to make pointing-based selections (e.g., often related to attention and/or interest), rates of overall progression when “discovering” new objects within the pages of serial content such as a book or magazine, and so on.

Such assessments may be compared with prior interactions by the same individual (e.g., to determine progress in particular topic areas), interactions using the same or similar interactive sequences by others (e.g., at the same age, cultural environment or educational level), and/or performance among different groups (e.g., comparing geographic, economic and/or social clusters).

Milestone responses demonstrating various aspects of cognitive processing (e.g., first indications involving distinguishing colors, differentiating phonemes and/or words, understanding numbers of objects, performing simple mathematical operations, gesture responses requiring controlled motor functions) may be particularly useful in monitoring childhood development, learning rates by older users, assessing if more challenging storylines might be presented, and/or enhancing engagement. Auditory, tactile and/or visual acuity may also be monitored by the portable device in an ongoing manner.

Optionally, the portable device and/or external processors may log interactions (e.g., for education and/or parental monitoring). Automated record-keeping of interactions, reading engagement, content, progression, vocabulary acquisition, reading fluency, and/or comprehension (e.g., including compared with other children at a similar age) may provide insight about a child's emotional and cognitive development.

Real-time and essentially continuous assessment of metrics such as literacy, reading comprehension, overall interest in reading, and skills development may help identify children (at an early stage, when interventions are most beneficial) who might benefit from additional support or resources. As examples, early intervention support may include adaptations for dyslexia, dyscalculia, autism, or identifying users who might benefit from gifted and talented programs.

Whether used in isolation or as a part of a larger system, a portable device that is familiar to an individual (e.g., to a child) may be a particularly persuasive element of audible, haptic and/or visual rewards during selections (or, conversely, notifying a user that a selection may not be a storyline component). The portable and/or handheld device may even be colored and/or decorated to be a child's unique possession. Along similar lines, audible feedback (voice, regional accent, overall volume) may be pre-selected to suit the preferences, accommodations (e.g., hearing abilities), skills and/or other abilities of an individual user.

According to further aspects of the systems and methods herein, a light beam emanating by the portable device may be generated using one or more diodes and/or digital light processing (DLP) projection methods. A light pattern within the beam may be structured to produce a pattern on the reflective surface using light-blocking filters, an addressable liquid crystal filter, an addressable array of light sources, and/or DLP projection elements. Further aspects of structuring light to convey content and/or to produce a recognizable pattern at a target distance from the portable device to a reflective surface and consequently, indirectly control the co-aligned camera's field-of-view, are more fully described in U.S. Pat. No. 11,989,357, filed Jul. 11, 2023, U.S. Pat. No. 12,125,407, filed Oct. 20, 2023 and co-pending application Ser. No. 18/597,855, filed Mar. 6, 2024, the entire disclosures of which are expressly incorporated herein by reference. The beam may also be turned off upon determining a match as a component of signaling success to a user. Such user signaling may additionally be conveyed using visual and/or haptic feedback. Conversely, leaving the beam turned on during interactions may indicate to the device user that further searching for a page object or location is expected. Using a light beam emanating from a handheld device as a pointing indicator in response to questioning and/or cues are further described in co-pending application Ser. No. 18/201,094, filed May 23, 2023, the entire disclosure of which is expressly incorporated by reference herein.

An action enacted by a portable device processor may include transmitting interactive information related to selections and/or verbal interactions to one or more remote devices where, for example, further action(s) may be enacted. Particularly when used in entertainment, educational and/or collaborative settings, an ability to transmit the results of verbal exchanges and making selections allows the portable device to become a component of larger systems. For example, when used by a child or learner, experiences (e.g., verbal interactions, selected objects) may be shared, registered, evaluated, and/or simply enjoyed with connected parents, relatives, friends and/or guardians. Further aspects of using a handheld device to connect with others are more fully described in U.S. Pat. No. 11,409,359 filed Nov. 19, 2021, the entire disclosure of which is expressly incorporated herein by reference.

Interactions involving book pages may be a shared experience with a parent, friend, guardian or teacher. Using a portable device to control the delivery of serial content is more fully described in U.S. Pat. No. 11,941,185, filed Dec. 29, 2022 and co-pending U.S. application Ser. No. 18/578,817, filed Feb. 26, 2024, the entire disclosures of which are expressly incorporated herein by reference. Sharing the control of advancing to a new page or panel to select objects when viewing a book or magazine is more fully described in U.S. Pat. No. 11,652,654, filed Nov. 22, 2021, the entire disclosure of which is expressly incorporated herein by reference.

Further, the portable device processor may include a “personality” driven by AI (i.e., an artificial intelligence personality or “AIP”), transformer models, LLMs and/or SLMs. An AIP instantiated within a portable device may enhance user interactions by including a familiar physical form, interactive format, and/or voice that may additionally include personal insights (e.g., nickname, likes, dislikes, preferences) within generated audible content. Human-machine interactions enhanced by an AIP are more fully described in U.S. Pat. No. 10,915,814, filed Jun. 15, 2020, and U.S. Pat. No. 10,963,816, filed Oct. 23, 2020, the entire disclosures of which are expressly incorporated herein by reference. Determining context from audiovisual content and subsequently generating conversation by a virtual agent based on such context(s) are more fully described in U.S. Pat. No. 11,366,997, filed Apr. 17, 2021, and U.S. Pat. No. 11,556,775, filed Jun. 3, 2022, the entire disclosures of which are expressly incorporated herein by reference.

When used in isolation (e.g., while reading a book), interactions using a portable device may eliminate requirements for accessories or other devices such as a computer screen, computer mouse, track ball, stylus, tablet or mobile device while making object selections and performing activities. Eliminating such accessories (often designed for an older or adult user) may additionally eliminate requirements by younger users to understand more complex interactive sequences involving such devices or pointing mechanisms.

Portable electronic devices may be ergonomically designed to be readily manipulated by either hand (or both hands) of a device user. Alternatively, portable devices may be affixed and/or manipulated by other parts of the human body. A device that interacts with a user to point a light beam toward objects may, for example, be affixed to an arm, wrist (e.g., similar to a so-called smart watch), leg, foot or head. Such positioning may be used to address accessibility issues for individuals with restricted upper limb and/or hand movement, individuals lacking sufficient manual dexterity to convey intent, individuals absent a hand, and/or during situations where hands may be required for other activities.

Physical attachment of the device to a body part may be aided by one or more supportive structures such as a headband, wrist strap, or shoulder or chest holster. Attachment of the portable device to a support structure may be aided by a configuration that allows quick and easy attachments and detachments. For example, one or more attachment points may be held magnetically, using a simple latch mechanism, and/or using a so-called hook and loop fastening system (e.g., manufactured by Velcro). Quick and easy attachments and detachments may facilitate employing (and purchasing) a single portable device using different body parts, or by different users, at different times. Additionally, distinct devices may be specifically designed (e.g., with different device body shapes and/or optical working distances) to be conveniently manipulated using different body parts.

Interactions using the portable device may additionally take into account factors associated with accessibility. For example, the size and/or intensity of symbols or images broadcast on one or more device displays and/or within the beam may accommodate visually impaired individuals. Pages or other media containing selectable objects may be Braille-enhanced (e.g., containing both Braille and images), and/or contain patterns and/or textures with raised edges. If an individual has a hearing loss over one or more ranges of audio frequencies, then those frequencies may be avoided or boosted in intensity (e.g., depending on the type of hearing loss) to project the audio interactive content generated by the portable device.

During activities that, for example, involve young children or individuals who are cognitively challenged, interactions may involve significant “guessing” and/or needs to guide a device user. Assisting a user during an interaction and/or relaxing the precision of pointing may be considered a form of “interpretive control”. Interpretive control may include “nudging” (e.g., providing intermediary hints) toward one or more target responses or reactions. Further aspects of interpretive control are more fully described in U.S. Pat. No. 11,334,178, filed Aug. 6, 2021, the entire disclosure of which is expressly incorporated herein by reference.

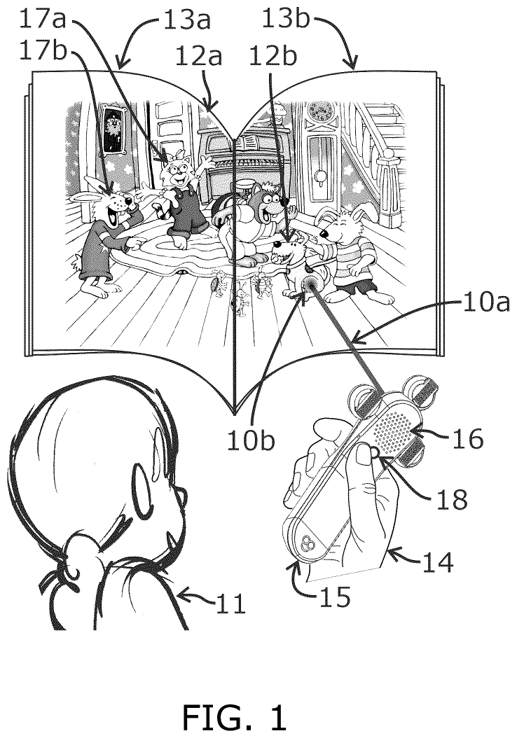

FIG. 1 shows an exemplary scenario in which a child 11 uses a right hand 14 to manipulate a light beam 10a generated by a handheld device 15 to point toward (and select) a page 13b and/or drawing of a dog at 12b. The dog 12b is one of several characters in a cartoon scene 12a within two pages 13a, 13b of a children's book. The child 11 is able to see a reflection 10b produced by the light beam 10a at the location of the canine form 12b within the rightmost page 13b of the printed book. The child may identify and select the rightmost page 13b and/or the dog 12b using the handheld device 15, resulting in audible feedback played on the device speaker 16.

Optionally, depressing a pushbutton 18 (or other signaling mechanism, such as vocal signaling [e.g., saying “OK”], detected by a device microphone; or movement gesture, dwell for a predetermined time, or handheld device orientation relative to the gravitational pull of the earth, sensed by an IMU) may be used to turn the light beam 10a on. Release of the pushbutton 18 (or other signaling mechanism) may be used to indicate that a selection has been made and, optionally, that the light beam 10a may be turned off (e.g., until another selection is to be made).

A portable device camera (not visible within the viewing perspective of FIG. 1) pointed toward the page in the same direction as the beam 10a may acquire one or more images of the region being pointed at by the light beam. Co-location of the light beam pointing region and the camera's field-of-view allows a page, page region and/or objects selected using the light beam to be identified within predetermined layouts of interactive book pages that may also contain ANN-based prompts and/or prompt elements.

The context of the dog within the page, or a portion of the page, may be considered during prompt generation (e.g., from one or more prompts within the selected page layout). The happy faces appearing within other animals in the scene (e.g., 17a, 17b) may indicate a happy storyline that might, for example, be accompanied by sounds of laughter.

Additionally, or alternatively, prompt design steps used to generate the audible interaction may, for example, focus on the dog (i.e., solely on the object being pointed at). In this case, prompts provided as input to an ANN may result in the sounds a dog might make (e.g., barking or growling, depending on prior interactions), or a poem, song or story about dogs.

Further, the storyline of an entire book, or a portion (e.g., chapter) of a book, may be included within ANN prompts. In this case, prompts may include historical and/or contextual information such as the dog's name, when the dog first appeared within the storyline, and so on. Along similar lines, expectations regarding what is about to happen with the ball in the mouth of the dog 12b (e.g., future components of the storyline) may be included within prompts to direct a trained ANN to generate timely audible interactive content.

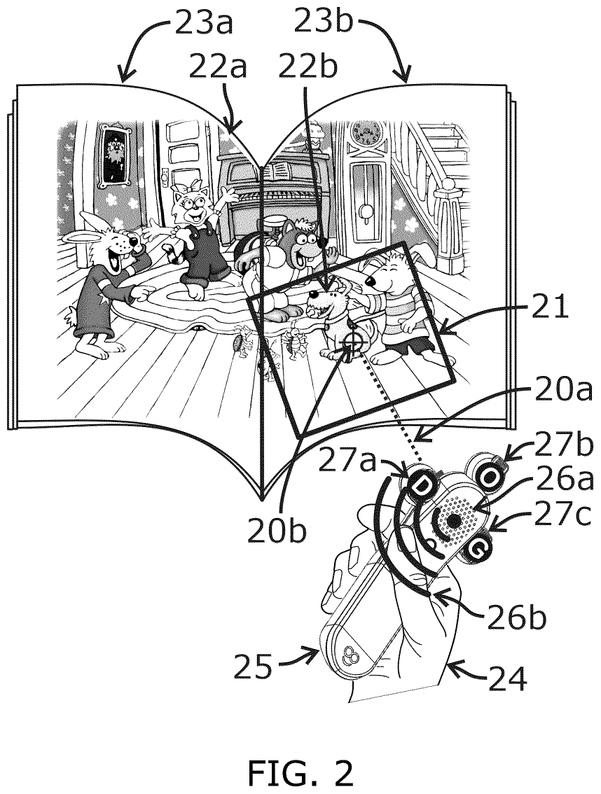

FIG. 2 follows on with the exemplary scenario illustrated in FIG. 1, showing a field-of-view of the handheld device camera at 21 within the two book pages 23a, 23b. As in FIG. 1, the handheld device 25 may be manipulated by a child's right hand 24 to point toward a selected page 23b, and/or region or objects (e.g., the dog 22b) within a cartoon scene 22a.

During acquisition of camera images, the light beam may be left on (e.g., typically generating a visible reflection off the page 23b) or, optionally, the beam may be momentarily (i.e., during camera acquisition) turned off as indicated in FIG. 2 by a dashed line traversing the beam path 20a (i.e., as if it were turned on). Because light paths of the beam and camera originate within the handheld device 25 and are pointed in the same direction, the location being pointed to by the beam (indicated by a cross-hair pattern at 20b) may be known within camera images, even when the beam is turned off. Turning the beam off during camera-based acquisitions may help CV-based processes to match camera images with locations within page layouts by avoiding image distortions produced by light beam reflections.

When a predetermined interactive page layout image, or portion of an image, is found that matches the field-of-view of the portable device camera image, the camera-acquired image 21 may be superimposed on the page layout image 23b, as illustrated in FIG. 2. This allows the beam location (i.e., known within camera images) to be determined within the selected page layout and/or its associated databases.

Knowing the location being pointed at by the device user triggers access to predetermined datasets associated with the selected page layout and/or regions (or locations) within the selected page. In the case illustrated in FIG. 2, information about the particular dog being pointed at, and/or the role of the dog within the context of the story may be played as one or more cues directly to the user and/or included as one or more ANN prompts. The device speaker 26a may, for example, announce 26b the word “dog”, produce barking sounds, and/or provide a proper name for the dog. The ANN may be prompted to add to the audible interaction, general information about dogs (e.g., different types of dogs, how dogs are related to other animals, a limerick about dogs).

In addition to audible interactions, visual and/or haptic feedback may be provided to the device user (e.g., originating from predetermined content within the page layout and/or due to ANN-based prompting). For example, the three spherical displays 27a, 27b, 27c on a handheld device may spell the word “DOG” (i.e., upon pointing at the dog 22b). Haptic stimulation generated by the handheld device may accompany barking sounds and/or acknowledge (using vibration) that an anticipated selection (e.g., in response to a query) has been made.

FIG. 3 is an exploded-view drawing of a portable device 35 showing exemplary locations for a light beam source 31a and a camera 36a. Such components may be internalized within the portable device 35 during final assembly. This view of the portable device 35 also shows the backsides of three spherical displays 37a, 37b, 37c attached to the main body of the device 35.

The light beam source may comprise, for example, a light-emitting diode 31a that may include embedded and/or external optical components (not viewable in FIG. 3) to form, structure and/or collimate the light beam 30. Beam generation electronics and optics may be housed in a sub-assembly 31b that provides electrical contacts for the beam source and precision control over beam aiming.

Along similar lines, the process of image acquisition may be achieved by light gathering optics 34a incorporated within a threaded housing 34b that allows further (optional) optics to be included in the light path for magnification and/or optical filtering. Optical components may be attached to a camera assembly 36a (i.e., including the image-sensing surface) that, in turn, is housed in a sub-assembly that provides electrical contacts for the camera and precision control over image acquisition direction.

An aspect of the exemplary configuration shown in FIG. 3 includes the light beam 30 and image-acquiring optics of the camera 34a pointing in the same direction 32. As a result, beam reflections off viewable objects occur within about the same region within camera-acquired images, regardless of the overall pointing direction and/or orientation of the portable device. Depending on relative alignment and separation (i.e., of the beam source and camera at 33), the location of the beam reflection may be centered (at a typical working distance) or offset somewhat from the center of camera-acquired images.

Small differences in beam location may occur at different distances from the portable device to a reflective surface due to the (designed to be small) separation at 33 between the beam source 31a and camera 36a. Such differences may be estimated using mathematical techniques analogous to those describing parallax. As a result, even if the beam is turned off (i.e., absent a beam reflection within camera images) beam locations may be determined based on where beam optics are pointed within the camera's field-of-view. Conversely, any measured shift in the location of the center (or any other reference) of a light beam reflection within a camera image may be used to estimate a distance from the portable device (more specifically, the device camera) to the viewable object based on geometry.

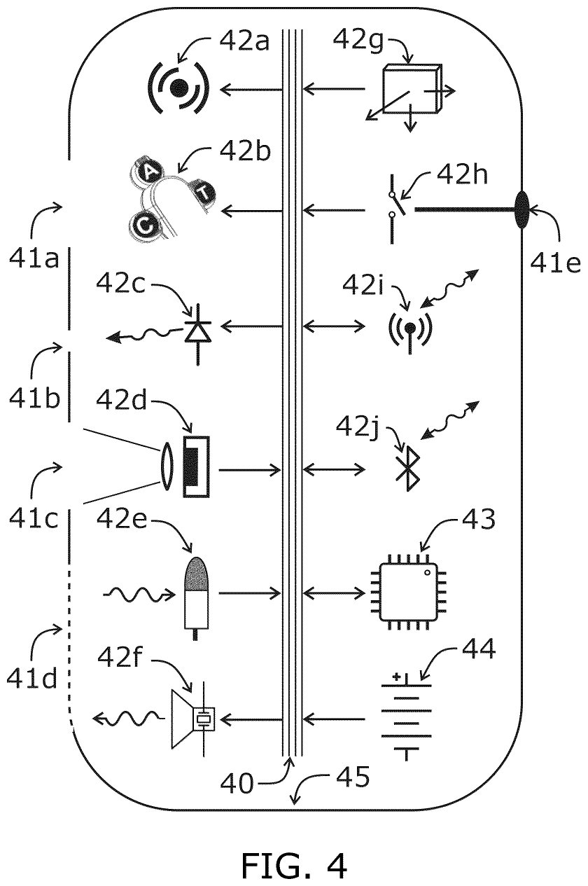

FIG. 4 is an exemplary electronic interconnection diagram of a portable device 45 illustrating components at 42a, 42b, 42c, 42d, 42e,42f, 42g, 42h, 42i, 42j, 43, 44 and predominant directions for the flow of information during use (i.e., indicated by the directions of arrows relative to an electronic bus structure 40 that forms a backbone for device circuitry). All electronic components may communicate via this electronic bus 40 and/or by direct pathways (not shown) with one or more processors 43. Some components may not be required or used during specific applications.

A core of the portable, handheld device may be one or more processors (including microcomputers, microcontrollers, application-specific integrated circuits (ASICs), field-programmable gate arrays (FPGAs), etc.) 43 powered by one or more (typically rechargeable or replaceable) batteries 44. As shown in FIG. 3, portable device elements also include a light beam generating component 42c (e.g., typically a light-emitting diode), and camera 42d to detect objects in the region of the beam (that may include a reflection produced by the beam). If embedded within the core of the portable device 45, both the beam source 42c and camera 42d may require one or more optical apertures and/or optical transparency (41b and 41c, respectively) through any portable device casing 45 or other structure(s).

A speaker 42f (e.g., electromagnetic coil or piezo-based) 42f may be used to play audio cues and ANN-generated audio interactive content. During such interactions, a microphone 42e may acquire sounds from the user and/or the environment of the device. If embedded within the portable device 45, operation of both the speaker 42f and microphone 42e may be aided by acoustic transparency through the portable device casing 45 or other structure(s) by, for example, coupling tightly to the device housing and/or including multiple perforations 41d (e.g., as further illustrated at 26a in FIG. 2).

During applications that, for example, include vibrational feedback and/or to alert a user that a selection might be expected, a haptic unit 42a (e.g., eccentric rotating mass or piezoelectric actuator) may be employed. One or more haptic units may be mechanically coupled to locations on the device housing (e.g., to be felt at specific locations on the device) or may be affixed to internal support structures (e.g., designed to be felt more generally throughout the device surface).

Similarly, during applications that include visual feedback or responses following object selection, one or more displays 42b may be utilized to display, for example, one or more colors, letters (as illustrated), words, images and/or drawings related to selected objects (or, for example, to indicate that an object has been incorrectly pointed at). Such one or more displays may be affixed and/or exterior to the main device body (as shown at 42b), and/or optical transparency may be employed within a device casing as indicated at 41a.

During typical interactions, a user may signal to the device at various times such as when ready to select another object, pointing at a new object, there is agreement about a previously selected object, and so on. User signaling may be indicated by verbal feedback sensed by a microphone, as well as movement gestures or physical orientation of the portable device sensed by an IMU 42g. Although illustrated as a single device at 42g, different implementations may involve distributed subcomponents that, for example, separately sense acceleration, gyroscopic motion, magnetic orientation, and gravitational pull. Additionally, subcomponents may be located in different regions of a device structure (e.g., distal arms, electrically quiet areas) to, for example, enhance signal-to-noise during sensed motions.

User signaling may also be indicated using one or more switch devices including one or more pushbuttons, toggles, contact switches, capacitive switches, proximity switches, and so on. Such switch-based sensors may require structural components at or near the surface of the device 41e to convey forces and/or movements to more internally located circuitry.

Telecommunications to and from the portable device 45 may, for example, be implemented using Wi-Fi 42i and/or Bluetooth 42j hardware and protocols (e.g., each using different regions of the electromagnetic spectrum). During exemplary scenarios that employ both protocols, shorter-range Bluetooth 42j may be used to register a device (e.g., to identify a Wi-Fi network and enter a password) using a mobile phone or tablet. Subsequently, Wi-Fi protocols may be employed to allow the activated device to communicate directly with other, more distant devices (e.g., content-generating processors) and/or the World Wide Web.

FIG. 5 illustrates an exemplary assembly of prompt element sources 50a, 50b, 50c, 50d, 50e, 50f, 50g that may be assembled to produce one or more prompts input 52 to an ANN 53 trained to generate audible interactive content 55a. An individual prompt may be generated from as little as a single prompt element (e.g., a question or directive from the device user sensed by a device microphone 50c) to assembling information from all prompt element sources 50a, 50b, 50c, 50d, 50e, 50f, 50g. In FIG. 5, optional component steps to generate audible interactions are indicated by a dashed-line outline.

Prompt elements may be classified into those related to the device user 50a, 50c, 50e, 50g and those related to the user environment 50b, 50d. Elements related to the user include background information about the user (e.g., name, age) at 50a, verbal interactions by the user sensed by a microphone at 50c, one or more user experiences (e.g., generated previously or during an ongoing interactive session) at 50e, and a page and/or page location pointed at using the device light beam at 50g. Prompt elements related to the user's environment may include learning or engagement goals (e.g., assigned by a parent, teacher or guardian) at 50b, one or more libraries of potential activities (e.g., poetry, mathematics, music, second language elements) at 50d, and/or collections of interactive page layouts (e.g., books) that may be identified via beam pointing at 51a.

Prompt elements may also be classified into those that may be preassigned (e.g., prior to an interactive session and/or carried over from one session to the next) including background information about the user 50a, any learning and/or engagement goals 50b, and collections of interactive page layouts (e.g., books) that may be identified by pointing the device beam 51a. On the other hand, prompt elements such as verbal input form the device user 50c, an identified page being pointed at using a light beam 51b, pointing location on the page 51c, and/or time of pointing 51d may be generated in real time during device use. User experiences 50e and libraries of activities 50d may be preassigned, but then updated during an interactive session. Preassigned user information 50a may include a name or nickname (e.g., helping to make audible interactions more personal), age (e.g., that may include a birth or anniversary date), one or more languages that may help direct audible wording, educational (e.g., knowledge, comprehension) and/or other skill levels, and/or interests (e.g., sports, arts, literature) and/or disinterests. A predetermined set of learning and/or engagement goals 50b may, for example, indicate one or more topic areas in which more detailed information may be explored (i.e., via the trained ANN), encourage engagement by being entertaining, focus on interests, introduce new (e.g., challenging) topics areas, be directed toward a particular library of potential activities 50d (e.g., those to emphasize physical movement), and so on.

Elements used to generate prompts may include layout information associated with an identified page 51b being pointed at using the device light beam as well as the beam pointing location within the page 51c. Optionally, prompts may be constructed based on object recognition (including OCR) at the pointing location within camera-acquired images; and/or one or more objects, contexts, and/or storylines associated with the pointing location within the identified page 51b and/or nearby page layouts 51a.

Optionally, the time that the device camera acquired the image used to generate prompts 51d may be included within ANN prompts. Acquisition time 51d may, for example, be valuable during question-and-answer sequences and/or to measure engagement. For example, rapid beam movement and location selection (e.g., following an ANN-generated description or query) might indicate interest in the subject matter and/or confidence in a response.

As illustrated in FIG. 5, prompt elements may be assembled at 52 for input to a trained ANN at 53. Depending on details of ANN implementation, ANN output may be on the form of text, phonemes, amplitude waveforms, musical scores, and so on. In some cases, (e.g., an ANN that outputs text) a text-to-speech and/or sound synthesis step may be required at 54. Sound waveforms at 55a may then be played on a device speaker at 55b. Additionally, the interactive sequence including the audible interaction may be appended to one or more records of user experiences at 50e (e.g., helping to avoid repetition).

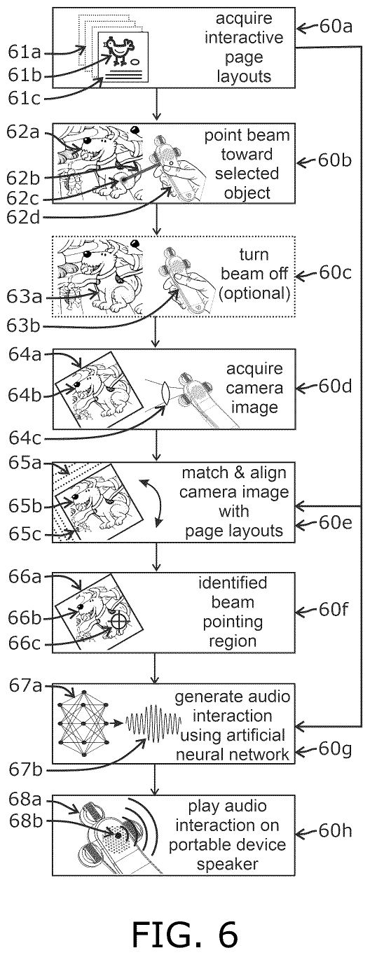

FIG. 6 is an exemplary flow diagram illustrating steps to produce ANN-based audio interactive content in which all processing steps are performed on the portable device 62d. The interactive sequence roughly follows the scenario illustrated in FIG. 1 in which the device user points a light beam 62b at a page containing an image of a dog 62a acquired by a device camera 64c. An interactive audio sequence is then generated based on prompt elements within the page layout of the identified page and, optionally, identifying the dog 62a pointed at using the beam along with other elements known about the storyline such as the time of acquiring the camera image, nearby text, other images or symbols within the page and/or other pages of the book. Steps in this content-generation process include:
1) at 60a, the processor of the portable device acquires predetermined interactive page layouts 61a that, for example, includes one page containing images associated with a bird at 61b and text at 61c (e.g., about the bird);
2) at 60b, the user points a light beam 62b generated by a portable device 62d toward a location at 62c of a cartoon image of a dog at 62a;
3) optionally (indicated by the dashed line outline), at 60c, the light beam emanating from the device 63b (pointed at an image of a dog) may be turned off (e.g., to avoid light beam reflections) prior to acquiring a camera-based image;
4) at 60d, using a camera (not visible) and focusing optics 64c (depicted apart from the body of the portable device for illustration purposes only), acquire an image in which the camera's field-of-view 64a includes the dog 64b;
5) at 60e, compare page layout images 65a previously acquired at step 60a with the camera-based image 65c (containing the dog 65b) to determine a best match and alignment within a page layout image;
6) optionally (indicated by the dashed line outline), at 60f, isolate a region of the camera image 66a that includes the location or region of light beam reflection 66c (whether the beam is turned on or not) indicating a canine section 66b by the device user;
7) at 60g, based on the selection(s) made using beam pointing along with any additional information (e.g., timing, adjacent page layouts) formulate prompts to be processed by an ANN 67a to generate one or more audio interactions 67b; and
8) at 60h, play the audible interaction on the speaker 68b of the portable device 68a.

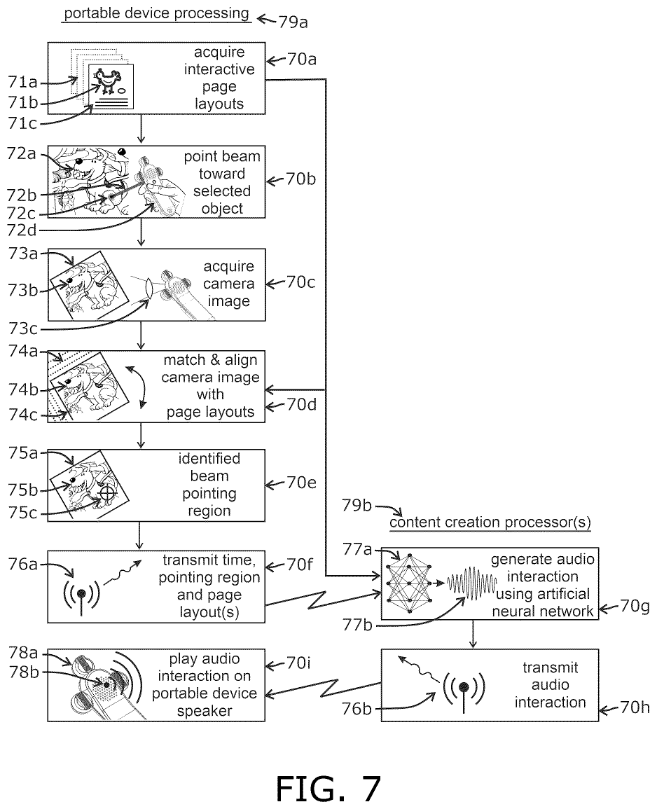

FIG. 7 is an exemplary flow diagram, similar to FIG. 6, except ANN-based processing to generate audible interactive content may primarily be generated using one or more content-creation processors 79b that may be external to processing within the portable device 79a. The portable device transmits the user selection(s) and additional data (e.g., time of image acquisition, selected page layout) as elements for prompt design at 70f to the one or more content-generation processors at 70g. Compared with portable device processing, substantially more computing resources (e.g., hardware acceleration, parallel processing, more highly trained neural networks) may be available within these external resources. Once one or more audio interactions have been generated at 70g, they may be transmitted back to the portable device at 70h to be played on the device speaker at 70i. Steps in this audio content generation process include:
1) at 70a, the processor of the portable device acquires interactive page layouts 71a, including both images 71b and text 71c;
2) at 70b, the user points a light beam 62b generated by the device 62d towards the body 62c of a dog at 62a;
3) at 70c, using a camera (not visible) and focusing optics 73c, acquire an image in which the camera's field-of-view 73a includes the dog 73b being pointed at;
4) at 70d, compare the camera-based image 74c (containing the dog 74b) with page layout images 74a to determine a best match and alignment;
5) optionally (indicated by the dashed line outline), at 70e, determine that the location of the light beam 75c directed by the user within the camera image 75a is in the region of a dog 75b;
6) at 70f, transmit (e.g., using wi-fi at 76a) the user's selection, timing and any additional information (e.g., selected page layout) to one or more audio content creation processors;
7) at 70g, based on the selection(s) made using beam pointing along with any additional information (e.g., timing, adjacent page layouts) formulate prompts to be processed by an ANN 77a to generate an audio interaction 77b;
8) at 70h, transmit (e.g., using wi-fi at 76b) audio interactive content to the portable device; and
9) at 70i, play the audio interactive content on the speaker 78b of the portable device 78a.

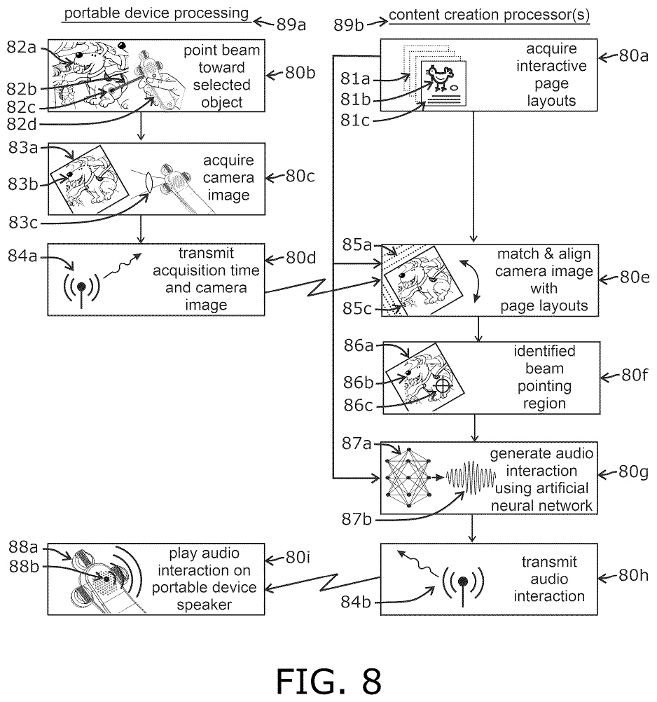

FIG. 8 is an exemplary flow diagram, expanding further upon elements of FIGS. 6 and 7, in which much of the more computationally intensive processing may be performed on one or more processors that are external to the portable device 89a. Processing by one or more external processors may include identifying pages being pointed at within camera images 80e, beam pointing locations within those pages 80f, prompt design and the ANN-based generation of audio interactive content 80g. Processing steps required on the portable device may be greatly reduced to those including acquiring camera images 80c, transmitting and receiving data to and from the one or more external processors 80d, and playing audio interactive content on the portable device speaker at 80i. Steps in this interactive process include:
1) at 80a, the one or more processors used for content generation may acquire interactive page layouts 81a, including, for example, both images 81b and text 81c;
2) at 80b, the user points a light beam 82b generated by the portable device 82d towards the body 82c of a dog at 82a;
3) at 80c, using a camera and focusing optics 83c, acquire an image in which the camera's field-of-view 83a includes the dog 83b being pointed at;
4) at 80d, transmit (e.g., using wi-fi at 84a) the camera image (and, optionally, image acquisition time) to one or more content creation processors;
5) at 80e, compare the camera-based image 85b with page layouts images 85a to determine a best match and alignment;
6) optionally (indicated by the dashed line outline), at 80f, determine that the location of the light beam 86c directed by the user within the camera image 86a is in the region of a dog at 86b;
7) at 80g, based on the selection(s) made using beam pointing along with any additional information (e.g., timing, adjacent page layouts) formulate prompts to be processed by an ANN 87a to generate an audio interaction 87b;
8) at 80h, transmit (e.g., using wi-fi at 84b) the audio interactive content to the portable device; and
9) at 80i, play the audio interactive content on the speaker 88b of the portable device 88a.

FIG. 9 expands some of the processing steps shown in FIG. 5, illustrating the handling of predetermined verbal cues and ANN prompts stored within a selected page and/or associated pages layouts 91a. When broadcast 93b, audible cues may elicit one or more verbal reactions by a device user 93c. The assembling of completed user reactions 96b and predetermined page layout prompts 94 may then be input to a trained ANN to generate audible interactive content 97.

More specifically, a book or collection of predetermined interactive page layouts 91 provide a basis for comparison with camera-acquired images to identify a selected page 92a and, optionally (indicated by a dashed line outline) a location or region within the selected page pointed at using a light beam produced by the portable device. Predetermined databases that include the collection of interactive pages layouts 91 (e.g., providing context and/or storyline), identified page (e.g., describing activities being viewed on a page) 92a and specified page location 92b (particular objects, including words, and their roles or functions within the storyline) may each be a source of verbal cues 93a and/or trained ANN prompts 94.

In some cases, cues and/or prompts may be scripted and/or conditional (e.g., based on a status of a real time state) and/or depend on information that may be available at the time when the portable device is being used. Background information about the device user 90a (e.g., age), and/or learning or engagement goals (e.g., provided by a parent or teacher) 90b may be available during an interactive session to help formulate both cues 93a and/or prompts 94. Once an audio cue is formulated, it may be played on a device speaker 93b.

Interactive audio (e.g., response) data spoken by the device user may be collected by a microphone 93c. To determine whether a sampled audio dataset (e.g., using analog-to-digital conversion methods, known in the art) comprises a complete declaration or question, a sampled dataset may be used as input to an ANN 95b trained (e.g., instructed using prompts) to identify completed questions or declarative sentences.

If a question or declaration has not yet been formed within the audio dataset 95a, then processing may continue at 96a to acquire additional audio data 93c. Generally, a device user is not made aware of such processing (i.e., no ANN-based audio output is generated during these steps). When a question or declarative statement has been accumulated and identified 96b, the completed question or statement may be combined with other prompt inputs 94 input to trigger machine-based production of audible interactive content at 97 (e.g., using sound broadcasting steps further illustrated in FIG. 5).

The foregoing disclosure of the examples has been presented for purposes of illustration and description. It is not intended to be exhaustive or to limit the invention to the precise forms disclosed. Many variations and modifications of the examples described herein will be apparent to one of ordinary skill in the art in light of the above disclosure. It will be appreciated that the various components and features described with the particular examples may be added, deleted, and/or substituted with the other examples, depending upon the intended use of the examples.

Further, in describing representative examples, the specification may have presented the method and/or process as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims.

While the invention is susceptible to various modifications and alternative forms, specific examples thereof have been shown in the drawings and are herein described in detail. It should be understood that the invention is not to be limited to the particular forms or methods disclosed, but to the contrary, the invention is to cover all modifications, equivalents and alternatives falling within the scope of the appended claims.

We claim:

1. A method to generate an audio interaction based on a selected page indicated by a device user using a portable device including a device processor, a device speaker operatively coupled to the device processor, a device light beam source configured to generate a projected light beam producing one or more light beam reflections, and a device camera aligned such that a camera field-of-view includes a projected beam location of the one or more light beam reflections and operatively coupled to the device processor, the method comprising:
acquiring, by the device processor, one or more predetermined interactive page layouts;
acquiring, by the device camera, a camera image when the portable device is manipulated by the device user such that the projected light beam produces the one or more light beam reflections off the selected page;
identifying, by the device processor, the selected page based on a match of the camera image to one of the one or more predetermined interactive page layouts;
generating, by the device processor, the audio interaction using one or more predetermined selected page layout prompts as one or more inputs to a trained artificial neural network; and
playing, on the device speaker, the audio interaction.

2. The method of claim 1, wherein the one or more inputs to the trained artificial neural network additionally comprise one or more of a time of acquiring the camera image, the selected page, a predetermined selected page layout, and the one or more predetermined interactive page layouts.

3. The method of claim 1, wherein the trained artificial neural network is one or both of a small language model and an agentic artificial intelligence.

4. The method of claim 1, wherein each of the one or more predetermined interactive page layouts includes one or more of a page image, one or more page prompts, one or more page audio cues, an object image of each of one or more page objects, an object identity of each of the one or more page objects, one or more object prompts associated with each of the one or more page objects, and one or more object audio cues associated with each of the one or more page objects.

5. The method of claim 4, wherein each of the one or more page prompts comprises one or more statements regarding page content, one or more contextual descriptions regarding the page content, one or more prompt questions regarding the page content, one or more object descriptions, one or more object function descriptions, one or more object associations with other book objects, one or more object sound descriptions, and one or more prompt directives.

6. The method of claim 4, further comprising playing, on the device speaker, one or both of the one or more page audio cues and the one or more object audio cues.

7. The method of claim 4, further comprising:
identifying, by the device processor, a specified page beam location based on a beam location of the one or more light beam reflections within the camera image superimposed on the page image of the selected page; and
including, by the device processor, the one or more object prompts of the one or more page objects at the specified page beam location within the one or more inputs to the trained artificial neural network.

8. The method of claim 1, wherein acquiring the one or more predetermined interactive page layouts comprises storing the one or more predetermined interactive page layouts in memory of the portable device.

9. The method of claim 1, wherein identifying the selected page comprises using one or more of template matching, computer vision, machine learning, transformer models, and neural network classification to determine the match of the camera image to one of the one or more predetermined interactive page layouts.

10. The method of claim 1, wherein the portable device further comprises a device microphone operatively coupled to the device processor, the method further comprising:
acquiring, by the device microphone, audio data;
identifying, by the device processor within the audio data, verbal content by the device user; and
including, by the device processor, the verbal content within the one or more inputs to the trained artificial neural network.

11. The method of claim 1, wherein the selected page is displayed on one of a book, a book cover, a brochure, a box, a sign, a newspaper, a magazine, a poster, a tablet, a printable surface, a painted surface, a textured surface, a flexible surface, and enhanced surface with one or more three-dimensional elements, a globe, a tattoo, a mobile device, an electronic book reader, a television, and a display screen.

12. The method of claim 1, wherein generating the audio interaction using the trained artificial neural network is supported by one or more of a mobile neural network, one or more microcontroller units and one or more artificial intelligence accelerators, each operatively coupled to the device processor.

13. The method of claim 1, wherein the portable device further comprises a switch operatively coupled to the device processor, the method further comprising acquiring the camera image upon activating the switch by the device user.

14. The method of claim 1, wherein the portable device further comprises a microphone operatively coupled to the device processor, the method further comprising acquiring the camera image upon determining an identified sound within data acquired from the microphone.

15. The method of claim 1, wherein the portable device further comprises an inertial measurement unit operatively coupled to the device processor, the method further comprising acquiring the camera image upon determining one of an identified motion, a lack of portable device movement for a predetermined dwell time, and an identified portable device orientation within data acquired from the inertial measurement unit.

16. A method to generate an audio interaction based on a selected page indicated by a device user using a portable device including a device processor, a device speaker operatively coupled to the device processor, a communications module operatively coupled to the device processor, a device light beam source configured to generate a projected light beam producing one or more light beam reflections, and a device camera aligned such that a camera field-of-view includes a beam location of the one or more light beam reflections and operatively coupled to the device processor, the method comprising:
acquiring, by one or both of the device processor and a content generating processor, one or more predetermined interactive page layouts;
acquiring, by the device camera, a camera image when the portable device is manipulated by the device user such that the projected light beam produces the one or more light beam reflections off the selected page;
identifying, by the device processor, the selected page based on a match of the camera image to one of the one or more predetermined interactive page layouts;
transmitting, from the device processor to the content generating processor using the communications module, one or both of a time of acquiring the camera image and the selected page;
generating, by the content generating processor, the audio interaction using one or more predetermined selected page layout prompts as one or more inputs to a trained artificial neural network;
receiving, by the device processor from the content generating processor using the communications module, the audio interaction from the content generating processor; and
playing, on the device speaker, the audio interaction.

17. The method of claim 16, wherein the one or more inputs to the trained artificial neural network additionally comprise one or more of a time of acquiring the camera image, the selected page, a predetermined selected page layout, and the one or more predetermined interactive page layouts.

18. The method of claim 16, wherein the trained artificial neural network is one or both of a large language model and an agentic artificial intelligence.

19. A method to generate an audio interaction based on a selected page indicated by a device user using a portable device including a device processor, a device speaker operatively coupled to the device processor, a communications module operatively coupled to the device processor, a device light beam source configured to generate a projected light beam producing one or more light beam reflections, and a device camera aligned such that a camera field-of-view includes a beam location of the one or more light beam reflections and operatively coupled to the device processor, the method comprising:
acquiring, by a remote processor, one or more predetermined interactive page layouts;
acquiring, by the device camera, a camera image when the portable device is manipulated by the device user such that the projected light beam produces the one or more light beam reflections off the selected page;
transmitting, from the device processor to the remote processor using the communications module, one or both of a time of acquiring the camera image and the camera image to the external processor;
identifying, by the remote processor, the selected page based on a match of the camera image to one of the one or more predetermined interactive page layouts;
generating, by the remote processor, the audio interaction using one or more predetermined selected page layout prompts as one or more inputs to a trained artificial neural network;
receiving, by the device processor from the remote processor using the communications module, the audio interaction from the remote processor; and
playing, on the device speaker, the audio interaction.

20. The method of claim 19, wherein the one or more inputs to the trained artificial neural network additionally comprise one or more of a time of acquiring the camera image, the selected page, a predetermined selected page layout, and the one or more predetermined interactive page layouts.

21. The method of claim 19, wherein processing by the remote processor is aided by one or more of additional processors, one or more microcontrollers, one or more graphics processing units, neural network hardware, one or more artificial intelligence accelerators, and cloud computing.

22. The method of claim 19, wherein the one or more inputs to the trained artificial neural network additionally comprise one or more of prompt statements regarding one or more of an age of the device user, an educational level of the device user, one or more skills of the device user, one or more educational goals for the device user, one or more liked topics of the device user, one or more disliked topics of the device user, one or more activities in which resources to perform the one or more activities are available to the device user, and one or more knowledge elements known by the device user.

23. The method of claim 22, wherein the one or more knowledge elements of the device user are updated by appending the audio interaction to the one or more knowledge elements.

24. The method of claim 19, wherein upon a first audio interaction being determined by the remote processor to be inappropriate for the device user, the trained artificial neural network is prompted to produce a replacement audio interaction.
